(19) United States
(12) Patent Application Publication
(10) Pub. No.: US 2025/0322762 A1
(43) Pub. Date: Oct. 16, 2025

(54) Automated Evaluation and Feedback of Participant Online Testing

(71) Applicant: 2hr Learning, Inc., Austin, TX (US)

(72) Inventors: Rakshit BhattUtsav Chokshi, Uttarakhand (IN); Nauman Ahmed, Karachi (PK); Utsav Chokshi, Gujarat (IN); Mayank Dave, Mumbai (IN); Omar Ahmed, Alexandria (EG); Saksham Mittal, Haryana (IN)

(73) Assignee: 2hr Learning, Inc., Austin, TX (US)

(21) Appl. No.: 19/177,471

(22) Filed: Apr. 11, 2025

Related U.S. Application Data
(60) Provisional application No. 63/632,989, filed on Apr. 11, 2024.

(51) Int. Cl. G09B 7/08; G06V 20/40; G06V 30/10

(52) U.S. Cl. CPC G09B 7/08; G06V 20/40; G06V 30/10

(57) ABSTRACT

A system and method automatically evaluate participant online testing and automatically provide feedback regarding test results of a participant. Automatic evaluation includes processing video frames, audio, timestamped screenshots, and initial test results of the participant answering multiple test questions and transcribing audio. The system and method utilize optical character recognition on the screenshots to generate a set of text for each screenshot and compare the set of text from each timestamped screenshot to determine which screenshots are associated with each test question. The system and method further determine time periods for each question, segment the transcribed audio, the screenshots, and the video frames by question and select a screenshot and a video frame for each test question from the segmented screenshots and video frames. The system and method utilize a first AI tool and a second AI tool to determine whether the participant demonstrated mastery for each test question.

### CROSS-REFERENCE TO RELATED APPLICATION

This application claims the benefit under 35 U.S.C. § 119(e) and 37 C.F.R. § 1.78 of U.S. Provisional Application No. 63/632,989, filed Apr. 11, 2024, which is incorporated by reference in its entirety.

### BACKGROUND

### Technical Field

A system and method generally relate to automated evaluation and feedback of participant online testing and, more specifically, to a computer-implemented system and method for automatically evaluating participant online testing and automatically providing feedback regarding test results and participant subject matter comprehension.

### Description of Related Art

Traditionally, teachers or other persons, collectively referred to herein as coaches, may test students or other persons, collectively referred to herein as test participants or participants, to evaluate their knowledge and understanding of a subject matter. Depending on the environment, the coaches may test the participants verbally, on paper, or online. A coach may provide interactive feedback with a given participant regarding their test results in a coaching session. The coach may perform the coaching session live during the test or after the test has been completed. During the coaching session, the coach may query the participant to determine their understanding of the test subject matter and then provide appropriate feedback to that participant.

Several tools are available for teaching, testing, and/or assessing participants, online and otherwise. The coach may utilize Bloom's Taxonomy as a hierarchical classification of knowledge and cognitive processes for developing and implementing a standards-based curriculum and for assessing the participant's understanding of the subject matter of that curriculum. The coach may also utilize Feynman techniques for teaching and assessing participant understanding of a given subject matter. There is also an existing application at www.schoolhouse.world, which implements online peer-to-peer tutoring of participants.

### SUMMARY

A method, system and/or computer usable program product for automatically evaluating participant online testing and automatically providing feedback regarding test results, including receiving notification to automatically evaluate a participant test including video with video frames, audio, timestamped screenshots, and initial test results of the participant answering multiple test questions, transcribing the audio; utilizing OCR on the screenshots to generate a set of text for each screenshot; comparing the set of text from each timestamped screenshot to determine which screenshots are associated with each test question; determining a set of time periods for each question based on the timestamps of the screenshots associated with each test question; segmenting the transcribed audio, the screenshots, and the video frames by question based on the determined set of time periods; selecting a screenshot and a video frame for each test question from the segmented screenshots and video frames; utilizing a first AI tool to generate an ideal answer for each test question; utilizing a second AI tool, with the ideal answer, the segmented transcribed audio, the selected screenshot and the selected video frame, for determining whether the participant demonstrated mastery, indicated knowledge gaps, or indicated antipatterns for each test question; generating a coaching report including the second AI tool determinations; and providing the coaching report to the participant.

### BRIEF DESCRIPTION OF THE DRAWINGS

Embodiments of a system and method for automatically evaluating participant online testing and automatically providing feedback regarding test results and participant subject matter comprehension may be better understood, and its numerous features and advantages made apparent to those skilled in the art by referencing the accompanying drawings. The use of the same reference number throughout the several figures designates a like or similar element.

FIG. 1 depicts a high-level block diagram of a comprehension determination and coaching system for online testing of a participant, automatically analyzing the participant's test-taking and test results, and automatically providing coaching reports based on the testing analysis.

FIG. 2 depicts a high-level flow diagram of the comprehension determination and coaching system performing online testing of a participant, automatically analyzing the participant's test-taking and test results, and automatically providing coaching reports based on the testing analysis.

FIGS. 3A-3B depict block diagrams of the comprehension determination and coaching system for online testing of a participant, automatically analyzing the participant's test-taking and test results, and automatically providing coaching reports based on the testing analysis.

FIGS. 4A-4E depict flow diagrams of the comprehension determination and coaching system performing online testing of a participant, automatically analyzing the participant's test-taking and test results, and automatically providing coaching reports based on the testing analysis.

FIGS. 5A-5E depict a displayed screenshot of a participant annotated test question, a displayed summary post-test coaching report, and displayed detailed post-test coaching reports.

FIG. 6 depicts a block diagram of an illustrative data processing system in which various embodiments of the present disclosure may be implemented.

FIG. 7 depicts a block diagram of an illustrative network of data processing systems in which various embodiments of the present disclosure may be implemented.

### DETAILED DESCRIPTION

Processes and devices may be implemented and utilized for automatically evaluating participant online testing and automatically providing feedback regarding test results and participant subject matter comprehension. These processes and apparatuses may be implemented and utilized as will be explained with reference to the various embodiments below.

In at least one embodiment, a method, computer program product and system is provided for automatically evaluating participant online testing and automatically providing feedback regarding test results and participant subject matter comprehension. In the present embodiment, automatic may refer to processes that are performed by devices without the need of human intervention.

A participant may take an online test with a webcam capturing audio of the participant explaining their thought processes, video capturing the participant's test taking including any participant handwritten notes, screenshots capturing the participant's annotations to the test questions, and the participant's answers to each question. The captured audio, video, screenshots may be timestamped. A test management system may transcribe the audio, then utilize optical character recognition (OCR) on each screenshot. The test management system may utilize the OCR'd screenshots to identify time periods for each test question, which is then utilized to segment the screenshots, audio transcription and video by test question.

The test management system may then utilize downloaded test questions with the correct answer with an AI tool to generate an ideal answer for each test question. For correctly answered questions, the test management system may utilize a second AI tool to determine whether the participant demonstrated mastery of correctly answered questions thereby indicating the participant comprehension of the underlying subject matter of those questions. For incorrectly answered questions, the test management system may utilize the second AI tool to determine whether the participant demonstrated knowledge gaps or antipatterns for those questions. The test management system may then generate a coaching report for the participant including these AI tool determinations.

The test management system and method set forth herein address technical issues with generating the desired outputs described herein. Conventionally, manual processes were used to generate the desired outputs and were very tedious and time consuming. The present test management system and method utilize an automated system that does not merely automate a manual process or use a conventional system in a conventional way. The present test management system and method utilize one or more artificial intelligence (AI) engines and integrate programmatic process management to technologically guide and constrain the one or more AI engines to produce the desired outputs in a completely different way than both any manual process and different than normal use of programs and AI engines. Utilizing specially engineered guidance and control to direct an AI system to solve the problems below presents a technical problem that requires a technical solution. The test management system and method described below are not simply engaging a computer to carry out conventional mental processes, but rather change how computers (and AI systems, specifically) operate to achieve the generation results that were not previously possible or were substantially inefficient prior to the test management system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the test management system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

A programmatic AI engine management system generates decomposed, technically engineered AI prompts to include selected and integral AI engine guidance and constraints. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine test management system and method is uniquely and unconventionally decomposed, and AI prompts are used to solve the decomposed problem. Furthermore, the programmatic inputs to the decomposed AI prompts provide guidance to meet desired output characteristics. For example, in an educational context, the prompts guide and constrain an AI engine as part of the test managmenet system and method to automatically evaluate participant online testing and automatically provide feedback regarding test results and participant subject matter comprehension

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the test management system and method described herein. Thus, the present test management system and method described implement an integration of programmatic management over decomposed prompts with engineered AI engine guidance and constraints to effect an improvement in AI, programmatic AI management, and AI integrated with programmatic management technology. The present test management system and method allow computer systems to include programmatic management, one or more AI engines, and one or more data sources to produce the outputs described herein that previously could not be produced with conventionally prompted AI engines or could only be produced by humans utilizing a completely different, time consuming, and tedious process. The test management system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

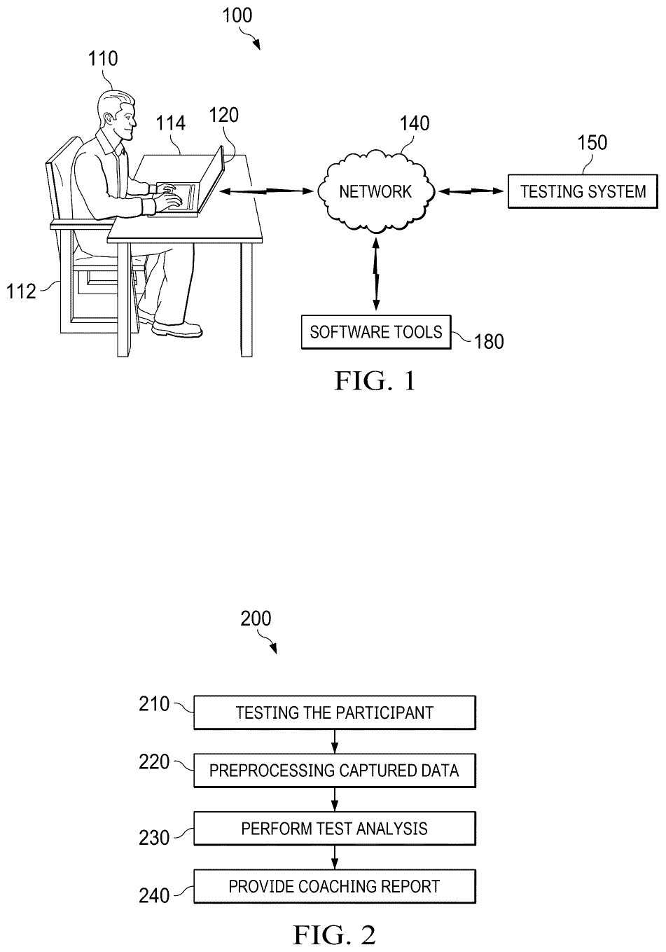

FIG. 1 depicts a high-level block diagram 100 of a comprehension determination and coaching system for online testing of a participant, automatically analyzing the participant's test-taking and test results, and automatically providing coaching reports based on the testing analysis. In the present embodiment, the participant may be a student taking the online test and receiving the results. Most of the examples provided below describe this use of the comprehension determination and coaching system (also referred to herein as a testing system). Alternatively, the participant may be an employment candidate taking the test with the coaching report provided to a potential employer. A person of ordinary skill in the art may also reasonably determine other testing system uses such as described herein.

In this embodiment, participant 110 may sit in chair 112 at desk 114, taking a test on a laptop 120 or other test-taking device. Although FIG. 1 depicts a single participant in the present example, the testing system may test and provide coaching reports to many participants on many test-taking devices concurrently, automatically, and on demand. The test-taking device may be a mobile phone, tablet, deskside computer, or other computing device. Laptop 120 may include a display for displaying the test and a resulting coaching report, a keyboard or other input device for the participant to select or otherwise provide a test answer, a video camera such as a webcam for videoing the participant taking the test and providing supplemental test-taking notes, and a microphone for recording the participant explaining their test-taking analysis and results. The test-taking device may not include or utilize a display in an alternative embodiment, such as for a visually impaired participant. Instead, it may use a loudspeaker or headphones to provide the test to the participant. Depending on the circumstances and environment, a participant may utilize other variants of test-taking devices.

Laptop 120 may securely communicate across network(s) 140 with testing system 150. Network(s) 140 may be the internet, a wide area network, a local network and/or a combination thereof, depending on the relative location of testing system 150 to laptop 120 and other factors known to those of ordinary skill in the art. Testing system 150 may also communicate with other software tools 180 across network(s) 150 for utilization of those software tools such as described herein. Network(s) 150 may utilize the internet to establish these communications between testing system 150 and software tools 180. Such software tools may include developed or licensed software residing on or accessible to testing system 150. Testing system 150 may be implemented as a server, a cloud-based system or application, or other configuration as may be appreciated by one of ordinary skill in the art.

FIG. 2 depicts a high-level flow diagram 200 of comprehension determination and coaching system 150 performing online testing of a participant 110, automatically analyzing the participant's test-taking and test results, and automatically providing coaching reports based on the testing analysis. This process includes four phases: testing 210 the participant, preprocessing 220 any captured test data, performing test analysis 230 on the preprocessed test data to determine test results, including participant comprehension of the underlying subject matter, and providing 240 a coaching report based on the test results.

In first phase 210, testing system 150 tests participant 110 across network(s) 140 and gathers data from the participant during the test. Testing system 150 may obtain, utilize otherwise provide the test from a test provider or other source. This testing may include providing online questions to the participant on laptop 120, taking screenshots of any annotations that the participant may make while answering each online question, and recording the video and sound of the participant answering each question. Testing system 150 may suggest to the participant that they provide an ongoing elaboration of their thinking process while answering each question on laptop 120, such as verbally for recording by the microphone, annotating the displayed question for capture by screenshots, or writing on paper and presenting that writing to the camera, such as a webcam, for recording. Test-taking device 120 may capture this test data, also referred herein to as test-taking data, for preprocessing by testing system 150 as described below.

In second phase 220, testing system 150 may receive the captured data from test-taking device 120, then automatically preprocess the captured test data in preparation for testing analysis. Preprocessing may include segmenting the captured test data by question. This segmentation allows for question-by-question analysis of the participant's test data, including determining their mastery of the underlying subject matter of a given question thereby indicating their comprehension of the subject matter of that question. Preprocessing may include utilizing a computer vision (CV) tool to identify the last screenshot for each question with the participant's annotations or to identify a lack of annotations. Preprocessing may also include utilizing an optical character recognition (OCR) tool to identify the video frame with the most recognizable characters in the participant's handwritten notes presented to the camera, such as a webcam, or to identify a lack of presented handwritten notes. In addition, processing may include utilizing an audio transcription tool to transcribe the audio captured during the test. Testing system 150 may then group the segmented test data into sets by question for testing analysis as described below.

In third phase 230, testing system 150 automatically performs test analysis by processing each set of segmented test data by question to determine a test score and the participant's comprehension of the underlying subject matter. Testing system 150 may utilize artificial intelligence (AI) processing to generate an ideal answer for each question. Alternatively, testing system 150 may obtain an ideal answer from historical data or the test provider. Testing system 150 may submit the ideal answers with the sets of segmented test data for AI processing to determine participant comprehension for each question. In addition, testing system 150 may submit the sets of segmented test data for AI processing to determine whether the participant exhibited specific antipatterns during the test, such as problem decomposition or diligence issues. In the present embodiment, antipatterns, also referred to herein as testing antipatterns or as carelessness, are identified patterns of behavior or circumstances that may negatively affect the test performance of a participant.

In fourth phase 240, testing system 150 automatically compiles and collates these testing analysis determinations of participant comprehension and antipatterns to generate a test result summary, referred to herein as a coaching report. This test result summary may include the participant's test score, test comprehension of the underlying subject matter, and any exhibited antipatterns. Testing system 150 may then compile and generate a set of coaching tips based on the test results summary. The testing system may provide some coaching results, including these coaching tips, to the participant, the coach and/or other responsible users. Upon receiving the coaching report, the participant may utilize the coaching tips and other information contained in the report to take corrective action toward improving their comprehension of the underlying subject matter and/or their test-taking skills. Alternatively, the participant's coach or other responsible users may utilize the coaching report to evaluate the participant's comprehension of the underlying subject matter, apparent knowledge gaps of the participant, and identified participant antipatterns to take appropriate action based on that evaluation.

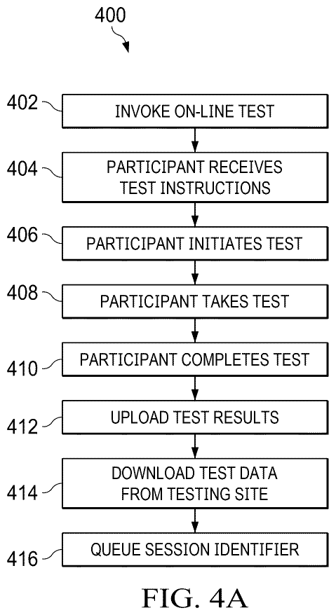

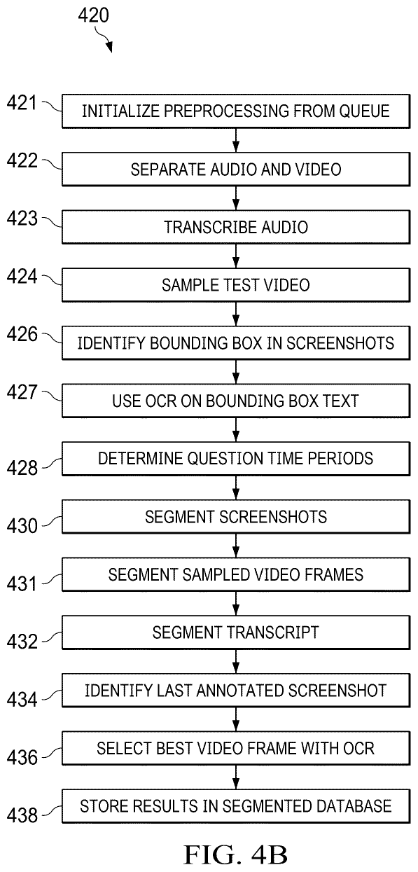

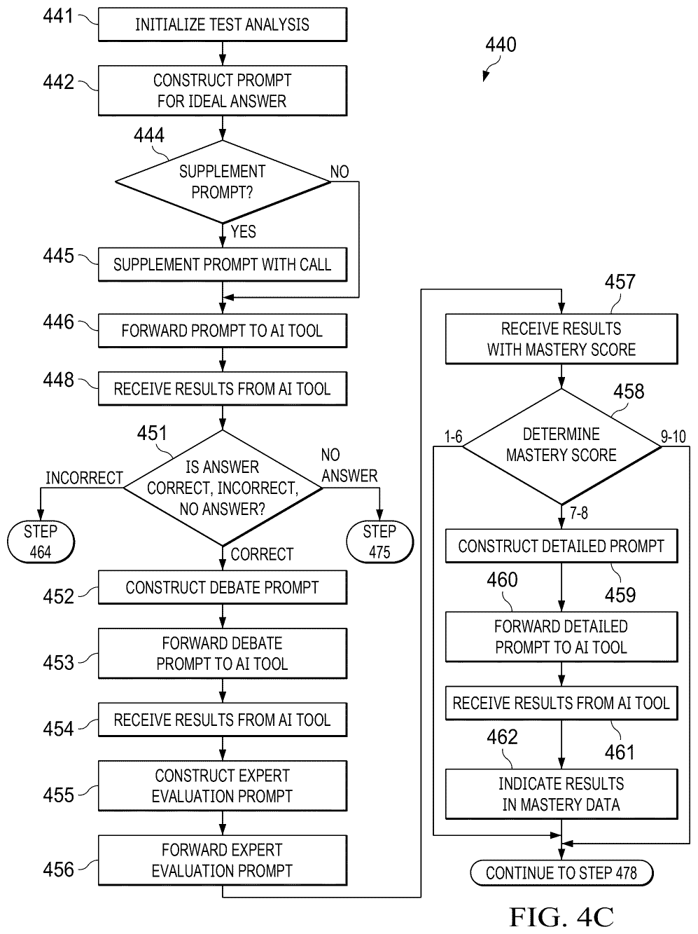

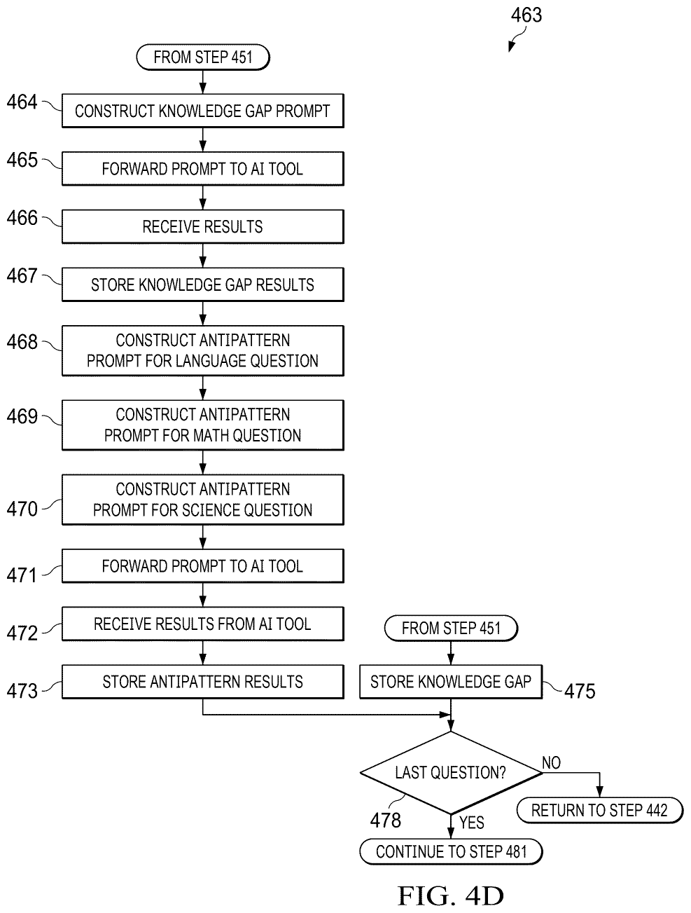

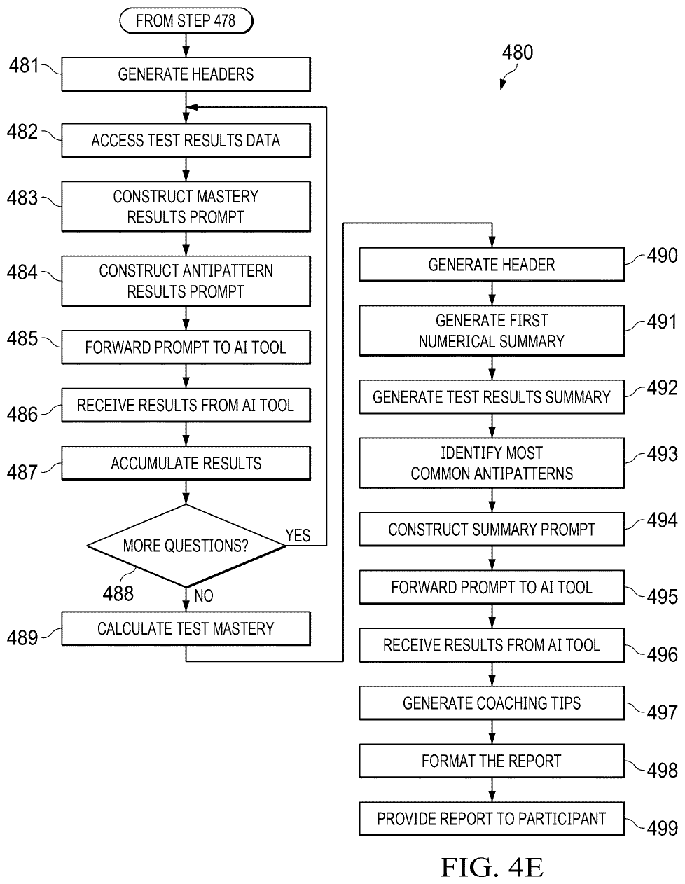

As may be appreciated by one of the ordinary skill in the art, alternative embodiments may perform or organize the above-described phases in a variety of ways, such as including the testing system generating the ideal answer for each question in the preprocessing phase. These four phases are described in greater detail below with reference to FIGS. 4A to 4D.

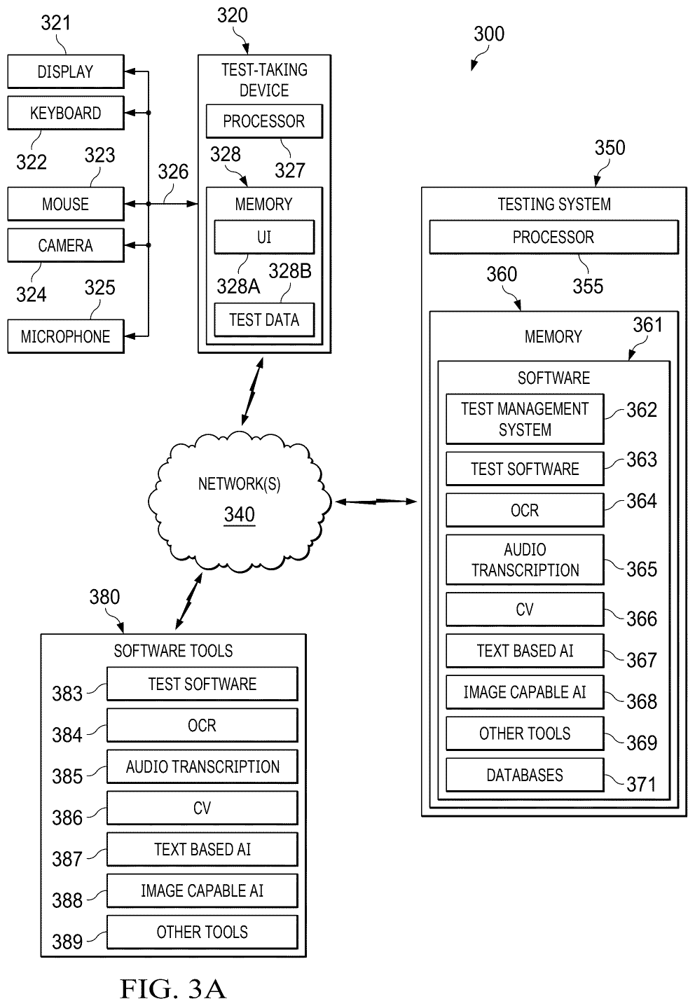

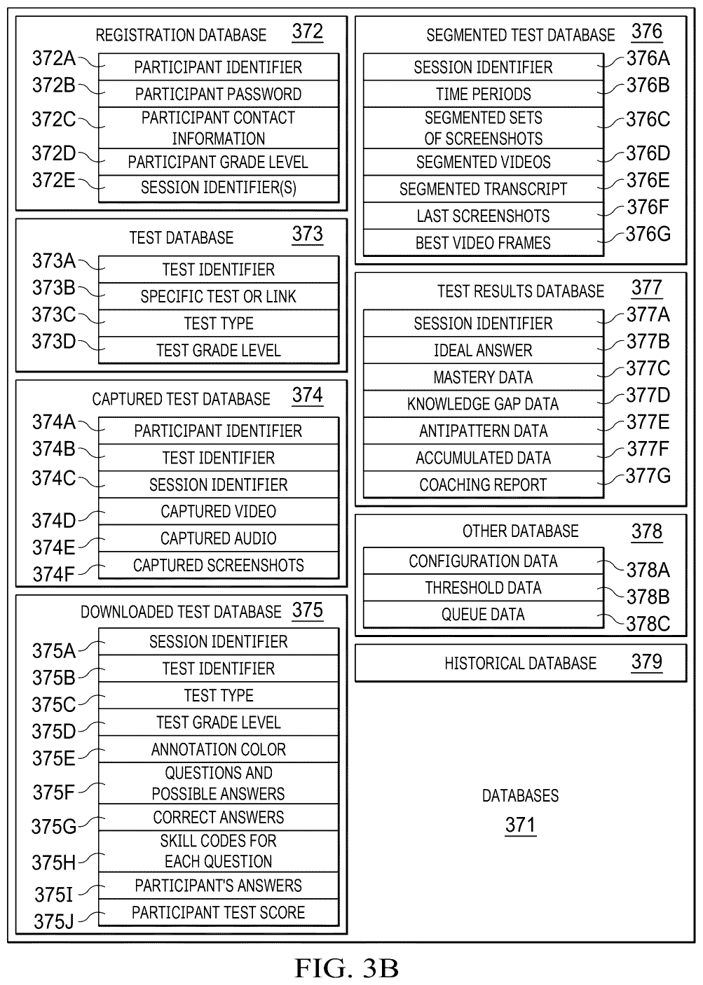

FIGS. 3A-3B depict block diagrams 300 and 371 of a comprehension determination and coaching system 350 for online testing of a participant through test-taking device(s) 320, automatically analyzing the participant's test-taking and test results, including utilizing remote software tools 380, and automatically providing coaching reports based on that testing analysis. The participant may take a test using test-taking device 320. Multiple participants may take one or more tests, concurrently or otherwise, using one of many test-taking devices such as a laptop, mobile phone, tablet, deskside computer, or other computing device. In the present embodiment, test-taking device 320 may include a display 321, a keyboard 322, a mouse 323, a camera 324, a microphone 325, and other input and output devices. The test-taking device may incorporate the input and output devices or couple with the input and output devices through an input/output interface 326. Test-taking device(s) 320 also includes a processor 327 and a memory 328. Memory 328 may store software such as user interface (UI) 328A for processing by processor 327 and captured test data 328B for storing audio, video, screenshots and other captured test data.

Testing system 350 may securely communicate with test-taking device(s) 320 through network(s) 340. Network(s) 340 may be the internet, a wide area network, a local network and/or a combination thereof, depending on the relative location of testing system 350 to test-taking device(s) 320 and other factors known to those of ordinary skill in the art. In an alternative embodiment, testing system 350 may be incorporated or otherwise included in a test-taking device 320.

Testing system(s) 350 may include a processor 355 and memory 360. Processor 355 may include one or more central processing units (CPUs), graphics processing units (GPUs), digital signal processors (DSPs), or other types of processing units. Memory 360 may include software 361 (i.e., sets of programming instructions) for execution by processor 355 and databases 371 for storing data for utilization by software 361. Such software may include test management system 362, test software 363, optical character recognition (OCR) software 364, audio transcription software 365, computer vision (CV) software 366, text-based artificial intelligence (AI) software 367, image capable AI software 368, and other software tools 369. Test management system 362 may utilize registration database 372 for registering a participant and for managing the subsequent process of analyzing the test results and generating a coaching report for the participant. Test software 363 may utilize test database 373 for managing test taking by the participant. Databases 371, shown in detail in FIG. 3B, may include registration database 372, test database 373, captured test data 374, downloaded test data 375, segmented test data 376, test results data 377, other data 378 and historical database 379. Databases 371 may include relational databases, flat files, excel spreadsheets, or other types of databases for storing and utilizing data such as described herein. In addition, such databases, flat files, excel spreadsheets or other types of databases may be combined into one or more databases or otherwise organized as may be appreciated by one of ordinary skill in the art.

Registration database 372 may include unique participant identifiers 372A, associated participant passwords 372B, associated participant contact information 372C, which may include a participant email or web address, and associated grade levels 372D of each participant. By having unique participant identifier 372A, associated password 372B, and/or associated contact information 372C, a participant or other user may access or otherwise receive a coaching report regarding the test results later. Registration database 372 may also maintain additional information regarding the participant such as prior tests taken by the participant and associated test results or demographic information regarding the participant for subsequent research purposes. In the present embodiment, session identifier(s) 372E may be utilized in the registration database. Session identifiers may be utilized to track one or more tests taken by the participant, such as through registration database 372 which could associate a given session identifier with a participant identifier and test identifier. Utilizing session identifiers could allow for anonymous testing which enabling maintaining historical data for a given participant. Test database 373 may include unique test identifiers 373A and specific tests 373B, or links to tests located at test software 383, which a participant may access for testing. For example, test identifier 373A may be a web address for a specific test or a unique identifier that may be utilized for identifying and accessing a given test. Each such test may include additional information such as the type of test (e.g., math, science, language, etc.) 373C, the grade level of the test 373CD, and other relevant information for selecting a test.

For each test taken by a participant, test taking device 320 may upload or store certain data captured while the participant takes the test, referred to herein as captured test data 374. In addition, testing system 350 or software tools 380 may retain and then download certain data regarding the test taken by the participant referred to herein as downloaded test data 375. Captured test data 374 may include a participant identifier 374A, identifying a participant in registration database 372, and a test identifier 374B identifying the test in test database 373 taken by that participant. In addition captured test data 374 may include a unique session identifier 374C associated with this participant and this test taken at a certain time and date. The use of session identifier 374C associated with the participant and test may allow the participant to take a given test multiple times and may also allow anonymous processing of the resulting test data. Also, if a session identifier is associated with a participant identifier in registration database 372 or in a separate session database, participant identifier 374A may not be included in captured test data 374. Captured test data 374 may also include captured video 374D, captured audio 374E, and captured screenshots 374F of the participant taking that test. Captured video 374D and captured audio 374E may be a single file captured by a video camera, such as a webcam, of the participant taking the test. Captured screenshots 374E may include screenshots of the participant's display while taking the same test. Downloaded test data 375 may include a session identifier 375A and an optional test identifier 375B identifying the particular test taken by a participant at a given time and date. In addition, downloaded test data 375 may include test type 375C (e.g., math, science, language, etc.), grade level 375D of the test, annotation color 375E, questions and possible answers 375F, correct answers 375G, skill codes for each question 375H, participant answers 375I, and participant's test score 375J, including identifying which questions were answered correctly, incorrectly or not answered. Alternatively, test data 375 may include a participant identifier rather than session identifier 375A.

Segmented test database 376 includes test data that has been segmented by question, thereby enabling efficient question by question analysis of the participant's answers, video, audio and screenshots. The segmented test database includes session identifier 376A, time periods 376B for each question segment, a segmented set of screenshots 376C for each question, a segmented set of video frames 376D for each question, a segmented transcript 376E by question, a last screenshot 376F for each question, and a best video frame 376G for each question.

Test results database 377 may include data generated by processing of segmented data with downloaded test data. Test results database may also be utilized for generating a coaching report for a participant for a given test taken by that participant. Test results database 377 may include a session identifier 377A, an ideal answer 377B for each question, mastery data 377C for each question, knowledge gap data for each question 377D, antipattern data 377E for each question, accumulated data 377F, and coaching report 377G. Mastery data 377C may include a determination whether the participant demonstrated mastery of a given question, thereby indicating comprehension of the underlying subject matter of that question, as well as evidence supporting that positive or negative determination. Knowledge gap data 377D may include a determination whether the participant demonstrated any knowledge gaps for a given question, an associated skill code or other indicator of the type of knowledge gap demonstrated, as well as evidence supporting that determination. Antipattern data 377E may include a determination whether the participant demonstrated certain antipatterns for a given question, the type of antipattern demonstrated, as well as evidence supporting that determination. The mastery, knowledge gap and antipattern evidence may be selected from one or more predetermined sets of possible evidence or may be provided in a prose or other format such as may be provided by an AI tool. Accumulated data 377F may include accumulated data regarding test analysis of each of the questions such as may be automatically compiled and collated in the fourth phase of the present embodiment and as described with reference to FIG. 4E below. Coaching report 377G may include a set of coaching reports generated utilizing accumulated data 377F and other data such as may be automatically generated in the fourth phase of the present embodiment and as described with reference to FIG. 4E below.

Some of the mastery, knowledge gap and antipattern data may be null for a given question indicating a lack thereof. For example, if a participant does not provide any verbalization, notes or annotations for a given question, then the test management system may not be able to utilize an AI tool to perform mastery, knowledge gap and antipattern analysis as described below other than determining whether the participant got the answer correct, thereby rendering the results of that analysis as inconclusive, which may be indicated by null data for those data fields. Also, if a participant answers a question correctly, then the test management system may not perform any antipattern analysis, which may be indicated by null data for that data field. Other types of data may be utilized to indicate inconclusive or other similar test analysis results.

Other data 378 may include other types of data utilized for managing the processes described herein. Other data 378 may include configuration data 378A, threshold data 378B and queue data 378C. Historical data 379 may include a variety of data which may be stored here. For example, ideal answers generated by the test management system may be stored here for future use or queried for identifying previously stored ideal answers.

As may be appreciated by one of ordinary skill in the art, testing system memory 360 may include many other types of software and databases, some of which may be developed internally or licensed from third parties. In addition, certain data such as downloaded test data 375 may be generated from OCR of screenshots or utilizing other methods and sources rather than downloading the data from test software 363 or 383. Testing system 350 may also be implemented as a server, a cloud-based system or application, or other configuration.

Testing system(s) 350 may communicate with or otherwise utilize other software tools 380 across network(s) 340 for utilization of those software tools such as described with reference to memory 360. Such software tools may be in a cloud environment, on servers accessible through web addresses across the internet, locally available on servers through an internal network, incorporated within the testing system, and/or otherwise available for utilization by the testing system. Software tools 380 may provide a variety of capabilities including test software 383, optical character recognition (OCR) 384, audio transcription 385, computer vision (CV) 386, text-based artificial intelligence (AI) 387, image capable AI 388, or other specialized capabilities. For example, software tools 380 may include a software tool that provides a variety of standardized tests such as Edulastic, which can be found at www.edulastic.com, a software tool that provides optical character recognition (OCR) such as Amazon Web Services Textract, which can be found at aws.amazon.com/textract, an audio transcription software tool such as Deepgram Nova-2, which can be found at www.deepgram.com, a computer vision (CV) tool to provide certain screenshot annotation recognition capabilities such as OpenCV, which can be found at www.opencv.org, a software tool to provide certain artificial intelligence capabilities such as ChatGPT and ChatGPT-4 Vision, which can be found at chat.openai.com, and other software tools such as Wolfram to provide solutions to equations, which can be found at www.wolfram.com, and IXL skill codes which can be found at www.IXL.com. Such software tools may include developed or licensed software residing on or accessible to testing system 350. Test software 383 may include test type, test grade level, test questions, test answers and associated skill codes for each question. Software tools 380 may be implemented as a server, a cloud-based system or application, or other configuration as may be appreciated by one of ordinary skill in the art. Testing system 350 may interface with software tools 380 through a variety of application program interfaces (APIs) utilizing data formats such as JavaScript Object Notation (JSON), by utilizing a user interface with an external application or website accessible across the internet, or other techniques as may be appreciated by one of ordinary skill in the art.

FIGS. 4A-4E depict flow diagrams of the comprehension determination and coaching system 350 performing online testing of a participant, automatically analyzing the participant's test-taking and test results, and automatically providing coaching reports based on the testing analysis. The testing system is described below as a batch process of steps whereby the participant completes the online test prior to the system's automatic determination of participant comprehension. Alternatively, the comprehension determination system may utilize a real-time or a question-by-question process. The following description is provided for one participant taking one test. Testing system 350 may repeat this process for multiple participants and multiple tests, whether serially or in parallel. The following steps are serialized into a linear sequence in four phases such as described above with reference to FIG. 2. That is, FIG. 4A corresponds to first phase 210, FIG. 4B corresponds to second phase 220, FIGS. 4C-4D correspond to third phase 230, and FIG. 4E corresponds to fourth phase 240. Testing system 350 may perform many of these steps described below in parallel or in a different order. Also, testing system 350 may perform many of these steps repeatedly, such as for each question, with the results assembled to perform specific test-wide steps and to provide the final test results.

FIG. 4A depicts a flow diagram 400 of first phase 210, testing the participant including recording the participant's testing process. In a first step 402, the test participant, a coach, or another responsible user may utilize user interface 328A of test-taking device 320 to access test management system 362 of testing system 350 to select and invoke or otherwise initiate an on-line test for the participant from test software 363 or 383. This may include test management system 362 generating a unique session identifier referencing this test for this participant. The person invoking the test may provide an email or other communication address of the participant and/or other users to testing system 350 for receiving a final coaching report regarding the participant's test. Optionally, this may be accomplished by utilizing a unique participant identifier 372A and associated password 372B for the participant from registration database 372. If someone did not register the participant previously, then the participant, coach or other responsible user may register the participant in registration database 372 at this time, including an associated password 372B for the unique participant identifier, an associated contact information 372C, which may include a communication email address or web address, and a grade level 372D of the participant. By having unique participant identifier 372A, an associated password 372B, and/or an associated contact information 372C, a participant or other user may access or otherwise receive a coaching report regarding the test results at a later time. In addition, this test selection may include selecting a specific test for the participant from various on-line tests in test database 373 or from test software 383. A test may be selected from test software 383 across the internet from a website of tests, which may be filtered by the grade level of the participant. This test selection may include choosing a specific test with a unique test identifier. By utilizing a unique participant identifier and test identifier, a history of the participant's tests and associated coaching reports may be maintained in historical database 379 to enable an evaluation of the participant's progress over time. In addition, anonymized coaching reports and associated data may be maintained in historical database 380 for subsequent analysis.

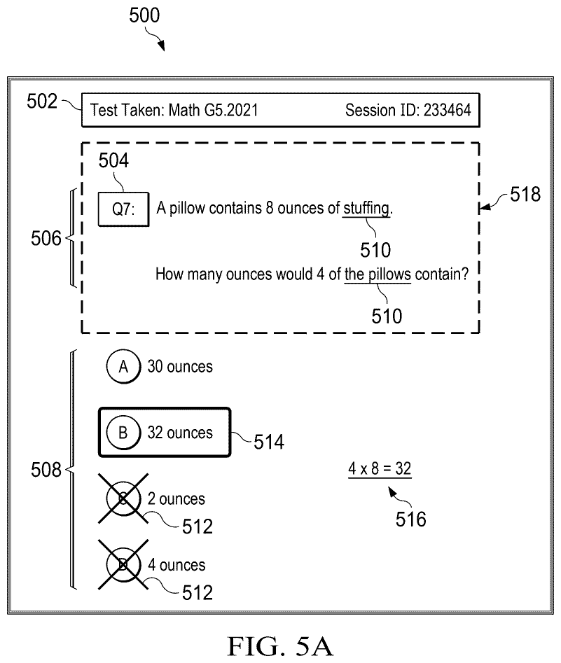

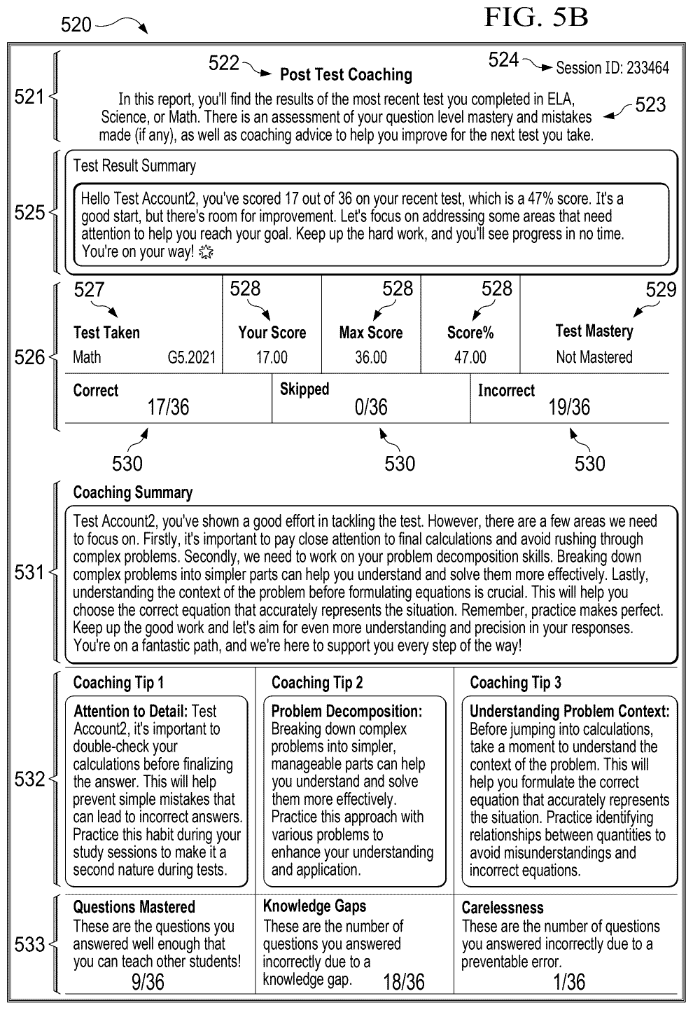

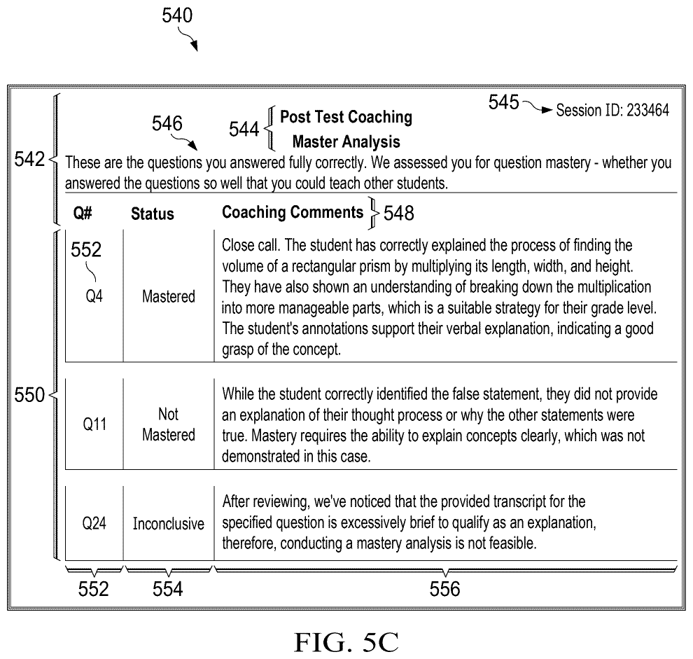

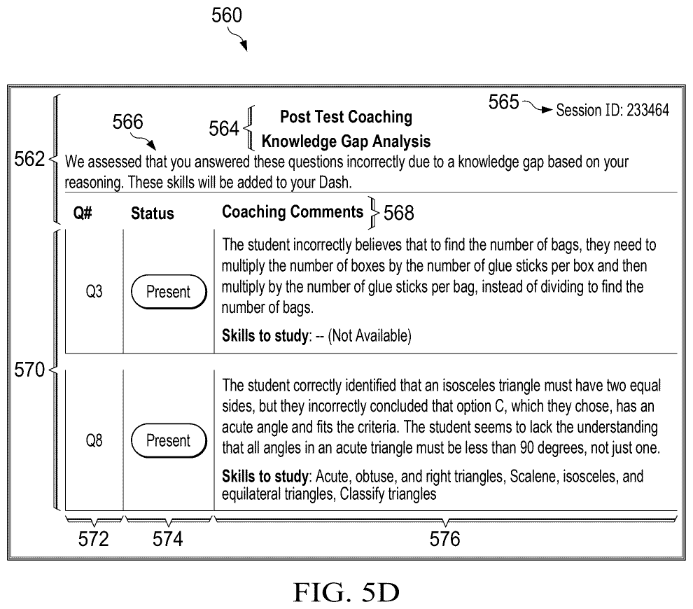

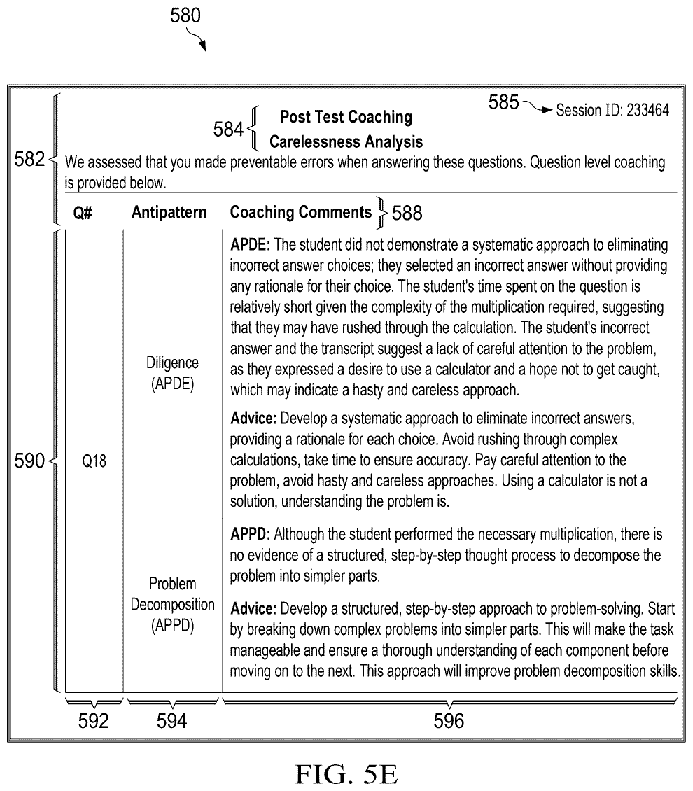

In step 404, the participant may receive test instructions from test management system 362 through user interface 328A on taking the test for display to the participant through display 321 or otherwise. These instructions may include directions to annotate the test on the display including using a separate color from the question text, to explain their test-taking thoughts and actions regarding their thought process for solving each question for recordation by camera 324, such as a webcam, and microphone 325, and to show any handwritten notes for recordation by camera 324. Annotations may include marking out a presumed wrong answer, underlining or otherwise marking the text, highlighting certain text, and writing or drawing in any white areas including equations, drawings or notes. An example of an annotated test question is described below with reference to FIG. 5A. These instructions may also explain how testing system may utilize these annotations, test-taking explanations and recorded handwritten notes to automatically provide an improved coaching report to the participant.

In step 406, responsive to test management system 362, test-taking device 320 may start the test while concurrently recording the participant taking the test through camera 324 and microphone 325. The test may be provided to the participant on display 321 by test software 383 of software tools 380 or test software 363 of testing system 350 such as through an internet website across network 340 or provided locally by the test-taking device. If provided locally, test-taking device 320 may have previously downloaded that test from test software 383 of software tools 380 or test software 363 of testing system 350 including the test type, test grade level, test questions, test answers and relevant skill codes describing the skills needed to master the underlying subject matter of the test. Such skill codes may be expressed as IXL skill codes. The camera and microphone may generate or otherwise capture a timestamped video 374A with audio 37A of the participant while taking the test, including participant explanations and presented handwritten notes. The system may utilize an independent universal time, a coordinated relative time, or other time indicators for the timestamps. The system may embed the timestamps in selected video frames or include a timecode within the video metadata, perhaps indicating a specific time for a given frame or when the video started. The test-taking device may utilize the camera and microphone to record or otherwise capture video with accompanying audio at a typical 20 to 60 frames per second or other framerate as desired as may be previously configured in configuration data 378A and downloaded from test management system 362. The video may be a continuous single recording or a series of recordings that may be stitched together, either virtually through pointers or by combining videos to form a single recording file. The video and audio may be recorded together in a single file or separately. In addition, test-taking device 350 may take timestamped screenshots of display 321 as the participant takes the test, thereby capturing the displayed questions, answers, and any participant annotations. Test-taking device 320 may capture screenshots about once per second or at another desired capture rate as may be previously configured in configuration data 378A and downloaded from test management system 362.

In step 408, the participant may utilize keyboard 322 and mouse 323, while viewing display 321, to take the test question by question. The participant may utilize the keyboard and mouse to annotate each test question, such as depicted in FIG. 5A below. The participant may explain their test-taking thoughts and actions regarding their thought process for solving each question for recordation by camera 324 and microphone 325, as well as holding up and showing their handwritten notes for each question for recordation by the camera. While this is ongoing, test-taking device 320 may store the session identifier, the participant identifier, the test identifier, video, audio and screenshots to each question as captured test data 328B in memory 328 and/or relay that captured test data live to testing system 350 as captured test data 374 for storage and subsequent processing there.

In step 410, the participant may indicate that they have completed the test. Then in step 412, test-taking device 320 may complete the storage of the audio, video and screenshots as captured test data 328B to memory 328 while turning off the camera 324, microphone 325 and screenshots of display 321. In step 412, responsive to test management system 362, test-taking device 320 may automatically upload or otherwise provide the stored audio, video and screenshots, collectively referred to herein as captured test data 328B, to test management system 362 of testing system 350 as captured video 374D, captured audio 374E and captured screenshots 374E for preprocessing unless the test-taking device performs that preprocessing. Test-taking device 320 may also upload or otherwise provide an associated participant identifier 374A, test identifier 374B and session identifier 374C to test management system 362 for indexing the captured data for preprocessing.

Then, in step 414, test management system 372 of testing system 350 may utilize the uploaded associated data (i.e., participant identifier 374A, test identifier 374B and/or participant session identifier 374C) for use in downloading certain test data 374 including the test type (e.g., match, science, language, etc.) 375C, test grade level 375D, annotation color (or other annotation indicator) 375E, test questions and possible answers 375F, correct answers 375G, associated skill codes for each question 375H, participants' answers 375I and participant test score 375J, including identifying which questions were answered correctly, incorrectly or not answered, from software tools 380. Test management system 362 may index this downloaded data by utilizing session identifier 374C as session identifier 375A and test identifier 374B as test identifier 375B. Test management system 372 may download or convert test questions 375F and correct answers 375G as JSON (JavaScript Object Notation) objects or other formats suitable for including text, equations and photos as well as other types of information which may be included in a question or answer (e.g., audio and video). Other downloaded data may be similarly downloaded, converted and/or stored as needed for processing as described herein. Skill codes may include IXL codes for identifying skills participants need to answer a certain question or test. Skill codes may also identify skills or expertise needed for a person to perform certain jobs or other tested functions. In an alternative embodiment, test-taking device 320 or testing system 350 may discern much of this data otherwise downloaded by performing OCR and subsequent analysis of screenshots 374C. In an alternative embodiment, step 414 may be performed as part of preprocessing test data such as described below. Finally, in step 416, test management system 372 may store session identifier 375A in queue data 378C for subsequent preprocessing and processing such as described below. Processing may then continue to FIG. 4B.

FIG. 4B depicts a flow diagram 420 of second phase 220, automatically preprocessing captured test data 374 including video 374D, audio 374E, and screenshots 374F of a particular test taken by the participant. In this embodiment, test-taking device 320 may have automatically uploaded this captured test data to testing system 350 as described above with reference to FIG. 4A. In addition, testing system 350 may have automatically utilized a session identifier and test identifier to download test data 375 including test type 375C, test grade level 375D, annotation color 375E, test questions and possible answers 375F, correct answers 375G, associated skill codes 375H, participant's test answers 375I, and participant's test score 375J from software tools 380 as well have stored session identifier 375A in queue data 378C. Testing system 350 may then preprocess captured test data 374 and downloaded test data 375 to generate segmented test data 376 by question and indexed with session identifier 376A as described below.

In a first step 421, test management system 362 may automatically initialize preprocessing of a completed test. This initialization may be prompted by the completion of the participant test by the participant, by the completed test reaching the front of queue data 378C of completed tests for analysis, by a request for analysis and a resulting coaching report by the participant or other person, or at other times as may be set forth by programming. Alternatively, such test analysis may be automatically initialized prior to completion of the test with some modifications to the following process

In step 422, test management system 362 of testing system 350 may automatically separate the captured test audio 374D from the captured test video 374C while maintaining timestamps for each. This step may not be necessary if they were recorded as separate files concurrently. Then in step 423, test management system 362 may automatically utilize audio transcription 365 or 385 to transcribe the captured test audio while associating the timestamps to associated text in the audio transcription. In step 424, test management system 362 may sample the captured test video at the same rate and times as the captured screenshots. That is, test management system may identify a set of captured test video frames that correspond to the set of captured screenshots and associate each of those sampled video frames to each of the screenshots. If there is a synchronization issue, such as where there may be a gap in captured screenshots for a particular period of time, test management system 362 may include blank frames for that time period to maintain synchronization between the sampled video frames and the captured screenshots. Alternatively, test management system 362 may utilize pointers or other techniques to compensate for the missing frames.

In step 426, test management system 362 of testing system 350 may automatically identify a bounding box for the screenshots, such as shown in FIG. 5A below, for identifying the approximate location of the displayed test questions in the screenshots. For example, many tests display the questions the top 20 percent of a display. This percentage may be varied based on the test type. For example, a language test may utilize more standard text for multiple questions than other types of tests. Testing system 350 may utilize the test identifier or other information, such as the test's web address or historical data 379, to identify the bounding box. Then, in step 427, test management system 362 may automatically utilize optical character recognition (OCR) 364 or 384 to generate text for the bounding box of each of the screenshots for the test. Then in step 428, test management system 362 may automatically determine a set of time periods 376B when the participant viewed each displayed question. Testing system 350 may compare each screenshot's text from the bounding box to determine when the participant viewed each question by looking for changes in text from screenshot to screenshot. Assuming the participant views the test questions sequentially, then the testing system may determine a corresponding order of the questions. Test management system 350 may also utilize the downloaded test questions from software tools 380 to identify the screenshots and an associated time period for each question. Time management system may also string together time periods where a participant views or otherwise accesses a particular test question more than once.

In step 430, test management system 362 may automatically segment and associate the screenshots into segmented screenshots 376C by question time period 376B. In step 431, test management system 362 may automatically segment and associate the sampled video frames into segmented videos 376D by question time period 376B. In step 432, test management system 362 may automatically segment and associate the audio transcript 376E by question time period 376B utilizing the associated timestamps. However, suppose the time period for a given question ends in the middle of a transcribed sentence. That is, a sentence may overflow a question's time period. In that case, test management system 362 may include the remainder of that sentence from the subsequent time period. Test management system may limit such consideration of overflow sentences to five seconds or other reasonable time period. At this point, the captured screenshots, the sampled captured video frames and the transcription of the captured audio may have been segmented by and associated with one of the test questions.

In step 434, test management system 362 may automatically utilize a computer vision (CV) tool 366 or 386 to identify a last screenshot 376F with participant annotations for each question. Test management system 362 may utilize the previously determined segmented screenshots to identify the screenshots for each question. The last screenshot with annotations for a given question may be assumed to have the most annotations for use as described below. The annotations may be a different color than the underlying questions and answers, which would enable easier identification of the screenshots with participant annotations for each question. Alternatively, the test management system could utilize the CV tool to compare each screenshot for a given question to the first screenshot of that question to identify which screenshots are annotated, and then select the last such annotated screenshot for that question. Rather than applying the CV tool to every screenshot for a given question, the test management system may start with the last screenshot for that question and work backwards to select the last screenshot with annotations. If the CV tool does not identify a screenshot with participant annotations for a given question for selection, then there may not be a selected screenshot for that question. In an alternative embodiment, test management system 362 may utilize the CV tool on all screenshots for each question, then perform additional comparative analysis to select the screenshot with the most annotations for each question.

In step 436, test management system 362 may automatically utilize an optical character recognition (OCR) tool 364 or 384 to select the sampled video frame with the most text for each question. This step is directed towards selecting the best sampled video frame 376G where a participant may have held up some handwritten notes for capture by the video camera. The test management system may apply OCR to sampled video frame for a given question to identify any text in each sampled video frames. If a sampled video frame has less than a threshold 378B number of characters, such as 10 or 15 characters, that video frame may be disregarded. Test management system 362 may then select the video frame with the most characters for each question based on the OCR results. If the OCR does not identify any characters for a given question, then there may not be a selected best video frame 376G, or a null entry, for that question. In step 437, test management system 362 may perform additional preprocessing on the selected screenshots 376F and the selected video frames 376G for each question including automatically converting them to greyscale and ensuring that their rotation is correct. This may enable better utilization of the selected screenshots and video frames by an AI tool such as described below. In step 438, the results of the above described preprocessing may be stored in databases 371 and session identifier 375A stored in queue data 378C for test analysis as described below.

As described above, test management system 362 may have preprocessed captured test data 374 and downloaded test data 375 to automatically generate a combination of sampled, segmented, and selected test data 376, all indexed with session identifiers 376A. This preprocessed and segmented test data may then be utilized as described below for automatically performing test analysis including determining participant comprehension, knowledge gaps and antipatterns as indicated by the participant's recorded test answers, annotated screenshots, video and audio recordings. Many of the above-described preprocessing steps may be performed concurrently or in a different sequence. For example, the test management system may automatically process the sampled video frames concurrently with the screenshots. Processing may then continue to FIG. 4C.

FIGS. 4C-4D depicts flow diagrams 440 and 463 of third phase 230, automatically generating grade appropriate ideal answers and analyzing the participant's test taking and test results in comparison to the ideal answers towards determining participant comprehension of the test subject matter, identifying apparent knowledge gaps, and detecting participant antipatterns while taking the test. In this embodiment, testing system 350 may have already downloaded and preprocessed captured test data 374 and downloaded test data 375 to generate segmented test data 376 indexed with session identifiers 376A as described above with reference to FIG. 4B. The following steps may be performed repeatedly for each test question, serially or in parallel. Alternatively, test management system 362 may perform the process of acquiring an ideal answer for each test question during the second phase of preprocessing or even earlier, such as when a participant starts a test. Alternatively, the participant's coach or other responsible users may utilize the coaching report to evaluate the participant's comprehension of the underlying subject matter, apparent knowledge gaps of the participant, and identified participant antipatterns to take appropriate action based on that evaluation

With reference to FIG. 4C, in a first step 441, test management system 362 may automatically initialize test analysis of a completed and preprocessed test. This initialization may be prompted by the completion of the preprocessing, by the preprocessed test reaching the front of queue data 378C of completed tests for analysis, by a request for analysis and a resulting coaching report by the participant or other person, or at other times as may be set forth by programming.

In step 442, test management system 362 may automatically construct an AI prompt for acquiring an ideal answer 377B for a test question from an AI tool, such as text based AI tool 367 or 387. This prompt may include question 375F, correct answer 375G and test grade level 375D. Alternatively, participant grade level 372D may be utilized in constructing the prompt, particularly if test grade level 375D is a range of grades. This prompt may include a query requesting a correct answer and grade appropriate explanation as may be provided by a tutor or other type of teacher explaining and walking through that answer. This prompt may also request this answer be formatted for subsequent use by this or another AI tool.

In step 444, test management system may automatically determine whether to supplement the prompt with a call to another AI tool, referred to herein as a supplemental AI tool, for a component of the test question. For example, if a test question and/or answer includes an equation component, the supplemental AI tool may be a specialized AI tool utilized to generate a step by step solution to that equation. Alternatively, all such prompts may include a conditional call or certain test types (e.g., math tests) may include a conditional call to the supplemental AI tool. If yes in step 444, then processing continues to step 445, otherwise processing continues to step 446.

In step 445 test management system 362 may automatically construct a call from the prompted AI tool (also referred to herein as the calling AI tool) to the supplemental AI tool within the prompt constructed in step 452. This call, whether conditional or not, may include a supplemental query to the supplemental AI tool requesting a supplemental answer to the test question component. This supplemental query may include the test question component (which may be automatically converted by the calling AI tool to a format appropriate for the supplemental AI tool) and a request to the supplemental AI tool to provide a step by step solution to the test question component. Depending on the supplemental AI tool, the supplemental query may also request that the provided solution include a grade appropriate explanation of the solution as may be provided by a tutor or other type of teacher explaining and walking a participant through that solution. Otherwise, the prompt to the calling AI tool (i.e., prompted AI tool) may include a request to that prompted AI tool to convert the step by step solution provided by the supplemental AI tool into a grade appropriate explanation of the solution as may be provided by a tutor or other type of teacher explaining and walking a participant through that solution. Processing may then continue to step 446. In an alternative embodiment, rather than utilizing a call to a supplemental AI tool within a prompt to the AI tool, a separate prompt may be automatically directed to the supplemental AI tool with the results incorporated into correct answer 375G and then included in the prompt to AI tool 367 or 387.

In step 446, test management system 362 may automatically submit the constructed prompt with associated data to the AI tool for the grade appropriate explanation of the solution as described above. In step 448, test management system 362 may receive the response from the AI tool and store that response as an ideal answer 377B in test results data 377. Test management system 362 may repeat the process for generating an ideal answer for each question for use as described below. In an alternative embodiment, ideal answers may be stored in historical data with the test identifier and grade level for future analysis and use. For example, rather than acquiring an ideal answer for every question of a given test for a given grade level, test management system 362 may first check historical database 379 for previously acquired ideal answers.

Processing of a given test question may vary depending on whether the participant answered the question correctly, answered the question incorrectly, or did not answer the question. If answered correctly, then test management system may assess whether the participant demonstrated mastery of the question subject matter. If the participant answered the question incorrectly, then the test management system may assess whether the participant has a knowledge gap pertaining to that question and assess whether the participant demonstrated any antipatterns. If the participant did not answer the question, then the test management system may assume the participant has a knowledge gap pertaining to that question.

In step 451, test management system 362 may determine whether the participant answered a given question correctly, incorrectly, or not at all. If the participant answered correctly, processing may continue to step 452. If the participant answered incorrectly, processing may continue to step 464. If the participant did not answer the question, then processing may continue to step 475.

Steps 452 to 462 describe a process of automatically assessing whether a participant demonstrates mastery of the subject matter of a correctly answered question thereby indicating participant comprehension of the question subject matter. In the present embodiment, test management system 362 utilizes a set of prompts, also referred to herein as a chain of prompts, to make this mastery assessment. The test management system may send each of these prompts to the same or different AI tools. Alternative embodiments may utilize a different set of one or more prompts to an AI tool to make this assessment. Because the participant answered the question correctly, test management system 362 does not look for antipatterns or for knowledge gaps for this question in the present embodiment. Alternative embodiments may perform such antipattern and knowledge gap analysis.

In step 452, test management system 362 may automatically construct a debate prompt for an AI tool requesting that the AI tool simulate a conversation between two teachers whether the participant mastered the question whereby one teacher argues that the participant mastered the question and the other teacher argues that the participant did not master the question, each teacher providing evidence supporting their arguments. In this debate, the test of mastery may be whether the participant provides a grade appropriate explanation of their answer such as may be provided by a tutor or other type of teacher explaining and walking through that answer for that grade. This prompt may include question 375F, correct answer 375G, test grade level 375D, ideal answer 377B, segmented transcript 376E, last screenshot 376F, and best video frame 376G. In step 453, test management system 362 may submit the automatically constructed debate prompt with associated data to the AI tool. Because the prompt may include images, the test management tool may submit the debate prompt with associated data to image capable AI tool 388. If the participant answer to this question did not include any images (e.g., the participant video was incomplete and/or no screenshot was available), then the test management system may utilize text based AI tool 387. In step 454, the test management system may receive the results of the debate prompt from the AI tool including a textual debate as requested.

In step 455, test management system 362 may automatically construct an expert evaluation prompt for an AI tool requesting that the AI tool evaluate the textual debate from step 454 as an education expert and provide a verdict score as well as supporting evidence for that verdict score. The verdict score may be from 1 to 10 indicating whether the participant mastered the question subject matter, whereby a score of 1 indicates poor mastery and a score of 10 indicates excellent mastery. In this debate, the test of mastery may be whether the participant provides a grade appropriate explanation of their answer such as may be provided by a tutor or other type of teacher explaining and walking through that answer for that grade. This expert evaluation prompt may include test grade level 375D and the textual debate from step 454. In step 456, test management system 362 may submit the automatically constructed expert evaluation prompt with associated data to the AI tool. Because this expert evaluation prompt may not include images, the test management tool may submit the debate prompt with associated data to text based AI tool 387. In step 457, the test management system may receive the results of the expert evaluation prompt from the AI tool including a mastery score as requested.

In step 458, test management system 362 may determine, based on the mastery score, whether the participant mastered the question, did not master the question, or whether further analysis is needed as well as supporting evidence for that determination. In the present embodiment, if the mastery score is 9-10, then the test management system may determine that the participant mastered that question and indicates that in mastery data 377C, and processing continues to step 478. If the mastery score is 1-6, then the test management system may determine that the participant did not master that question and indicates that in mastery data 377C, and processing continues to step 478. If the mastery score is 7-8, then processing may continue to step 459 for additional assessment whether the participant mastered the question. Alternative embodiments may utilize other scoring systems or other techniques for assessing question mastery from a textual debate as may be appreciated by one of ordinary skill in the art.

In step 459, test management 362 may further determine, for cases where the mastery score is 6-7, whether the participant mastered the question or not. In the present embodiment, test management system 362 may apply a grade appropriate three part test for these initially indeterminate cases. The test management system may automatically construct a detailed prompt including a grade appropriate assessment whether the participant demonstrated any possible knowledge gaps in understanding the underlying subject matter of the question as identified by the question skill codes, whether the participant provided a simple explanation sufficient to enable another person to understand the underlying subject matter of the question, and whether the participant explanation is sufficient for another person to have no doubts that they understand the underlying subject matter of the question. This detailed prompt may be predesigned with customizable parameters such as subject, grade and question. Although shown as a single prompt, this detailed prompt may be set forth as multiple prompts to be applied in parallel or serially. This detailed prompt may include question 375F, correct answer 375G, test grade level 375D, test skill codes 375H, and segmented transcript 376E. In step 460, test management system 362 may submit the automatically constructed detailed prompt with associated data to the AI tool. Because this detailed prompt may not include images, the test management tool may submit the detailed prompt with associated data to text based AI tool 387. In step 461, the test management system may receive the results of the detailed prompt from the AI tool including a three part determination of question mastery. Then in step 462, the results of the detailed prompt may be indicated in mastery data 377C. That is, if the participant passed all three tests of the detailed prompt, then the test management system may determine that the participant mastered that question. In that case, test management system 362 may indicate that determination in mastery data 377C, and processing continues to step 478. However, if the participant did not pass all three tests of the detailed prompt, then the test management system may determine that the participant did not master that question. In this case, test management system 362 may indicate that determination in mastery data 377C with the supporting evidence, and processing continues to step 478.

Referring to FIG. 4D, steps 464-467 describe a process of automatically assessing whether a participant indicates knowledge gaps of the subject matter of an incorrectly answered question. In the present embodiment, test management system 362 utilizes a set of prompts to make these assessments. The test management system may send each of these prompts to the same or different AI tools. Alternative embodiments may utilize a different set of one or more prompts to an AI tool to make these assessment. Because the participant answered the question incorrectly, test management system 362 does not look for mastery of the underlying subject matter for this question in the present embodiment.

In step 464, test management system 362 may automatically construct a knowledge gap prompt for an AI tool requesting that the AI tool determine whether the participant provided a grade appropriate explanation of their answer to that question, such as may be provided by a tutor or other type of teacher explaining and walking through that answer for that grade, to indicate knowledge of the underlying subject matter of the question. The knowledge gap prompt may include a request to provide supporting evidence for that determination such as may be provided by a teacher. The underlying subject matter of the question may be identified by the skill codes associated with that question. This prompt may include question 375F, correct answer 375G, test grade level 375D, question skill codes 375H, ideal answer 377B, segmented transcript 376E, last screenshot 376F, and best video frame 376G. In step 465, test management system 362 may submit the automatically constructed knowledge gap prompt with associated data to the AI tool. Because the prompt may include images, the test management tool may submit the knowledge gap prompt with associated data to image capable AI tool 388. If the participant answer to this question did not include any images (e.g., the participant video was incomplete and/or no screenshot was available), then the test management system may utilize text based AI tool 387. In step 466, the test management system may receive the results of the knowledge gap prompt from the AI tool including identifying any knowledge gaps and supporting evidence. These knowledge gaps may be identified as skill codes. In step 467, the test management system may store any identified skill codes and supporting evidence as knowledge gap data 377D, and processing continues to step 468 to identify any antipatterns.

Steps 468-473 describe a process for automatically identifying antipatterns in how the participant answered the incorrectly answered question. An antipattern may be an identified type of response or lack of response to a question that may lead to an incorrect answer. In the present embodiment, antipatterns, also referred to herein as testing antipatterns or as carelessness, are identified patterns of behavior or circumstances that may negatively affect the test performance of a participant. For example, a participant may not sufficiently describe decomposing a question while utilizing a structured thought process. This decomposition antipattern may indicate problem decomposition issues and/or possible knowledge gaps. Test management system 362 may generate AI tool prompts to identify these antipatterns that may vary by the type of test. That is, the test management system may look for different antipatterns in a math question than in a language question. The following describes utilizing an AI tool for identifying certain antipatterns for language, math and science questions. As may be appreciated by one of ordinary skill in the art, test management system may utilize an AI tool to identify other types of antipatterns for these and other types of test questions.

In step 468, for a language question, as indicated by test type 375C, test management system 362 may generate one or more language antipattern prompts for an AI tool requesting that the AI tool evaluate whether there were any detectable antipatterns for that question. That is, generated AI prompt may request the AI tool to evaluate the question, transcript, video, and screenshot to identify any apparent antipatterns for that question as well as supporting evidence for that identification. The AI tool may be prompted to identify specific antipatterns including whether the participant contextualized the question, referred to the text of the question, demonstrated diligence, and was not subject to distractions. Each of these antipatterns may include one or more aspects, also referred to herein as antipatterns or subset antipatterns, for inclusion in the antipattern prompt. For example, contextualizing the question may include whether the participant annotated or took notes on what they believe is important in the question, and described or summarized each paragraph of the question. Referring to the text of the question may include whether the participant read out loud parts of the text, underlined and otherwise annotated keywords in the text, and checked the possible answers against the question. Demonstrated diligence may include whether the participant took notes, annotated the text, and double checked their work. Distractions may include whether the participant experienced ambient sounds, accessed mobile devices or other applications, and whether the participant experienced other observable distractions. The test management system may include additional antipatterns and additional indicators in the language prompt for identification by an AI tool. This language prompt may include question 375F, test grade level 375D, segmented transcript 376E, segmented video 376D and last screenshot 376F.

In step 469, for a math question, as indicated by test type 375C, test management system 362 may generate one or more math antipattern prompts for an AI tool requesting that the AI tool evaluate whether there were any detectable antipatterns for that question. That is, generated AI prompt may request the AI tool to evaluate the question, transcript, video, and screenshot to identify any apparent antipatterns for that question as well as supporting evidence for that identification. The AI tool may be prompted to identify specific antipatterns including whether the participant decomposed the question, decontextualized the question, demonstrated diligence, and was not subject to distractions. Each of these antipatterns may include one or more aspects, also referred to herein as antipatterns or subset antipatterns, for inclusion in the antipattern prompt. For example, question decomposition may include whether the participant identified the relevant inputs, listed or described the relevant data, and identified steps towards solving the problem, whether verbally or by annotations or notes. Question decontextualization may include whether the participant annotated or described pertinent information, explained how they may utilize that information to answer the question, and transformed textual information into a mathematical equation. Demonstrated diligence may include whether the participant took notes, annotated the text, and double checked their work. Distractions may include whether the participant experienced ambient sounds, accessed mobile devices or other applications, and whether the participant experienced other observable distractions. The test management system may include additional antipatterns and additional indicators in the math prompt for identification by an AI tool. This math antipattern prompt may include question 375F, test grade level 375D, segmented transcript 376E, segmented video 376D and last screenshot 376F.

In step 470, for a science question, as indicated by test type 375C, test management system 362 may generate one or more science antipattern prompts for an AI tool requesting that the AI tool evaluate whether there were any detectable antipatterns for that question. That is, generated AI prompt may request the AI tool to evaluate the question, transcript, video, and screenshot to identify any apparent antipatterns for that question as well as supporting evidence for that identification. The AI tool may be prompted to identify specific antipatterns including whether the participant decomposed the question, decontextualized the question, demonstrated diligence, and was not subject to distractions. Each of these antipatterns may include one or more aspects, also referred to herein as antipatterns or subset antipatterns, for inclusion in the antipattern prompt. For example, question decomposition may include whether the participant identified the relevant inputs, listed or described the relevant data, and identified steps towards solving the problem, whether verbally or by annotations or notes. Question decontextualization may include whether the participant annotated or described pertinent information, explained how they may utilize that information to answer the question, and transformed textual information into a mathematical equation. Demonstrated diligence may include whether the participant took notes, annotated the text, and double checked their work. Distractions may include whether the participant experienced ambient sounds, accessed mobile devices or other applications, and whether the participant experienced other observable distractions. The test management system may include additional antipatterns and additional indicators in the science prompt for identification by an AI tool. This science antipattern prompt may include question 375F, test grade level 375D, segmented transcript 376E, segmented video 376D and last screenshot 376F.

In step 471, test management system 362 may submit the automatically constructed language, math or science antipattern prompt with associated data to the AI tool. Because the prompt may include images, the test management tool may submit the antipattern prompt with associated data to image capable AI tool 388. If the participant answer to this question did not include any images (e.g., the participant video was incomplete and/or no screenshot was available), then the test management system may utilize text based AI tool 387. In addition, the test management system may use different AI tools for language, math or science prompts. In step 472, the test management system may receive the results of the antipattern prompt from the AI tool including identifying any antipatterns, aspects associated with those antipatterns, and evidence supporting the identified antipatterns. In step 473, the test management system may store any antipatterns, their associated aspects and supporting evidence as antipattern data 377E, and processing continues to step 478.

Step 475 describes a process of identifying participant indicated knowledge gaps of the subject matter of an unanswered question. In the present embodiment, test management system 362 may assume by not answering a question, the participant is indicating a knowledge gap of the underlying subject matter of the question, particularly if the test is not timed. As a result, the test management system may simply store question skill codes 375H as knowledge gap data 377D for that question, with the lack of an answer as supporting evidence. Because the participant did not answer the question, test management system 362 may not look for mastery of the underlying subject matter or antipatterns for this question in the present embodiment. Processing continues to step 478.

In step 478, it is determined whether the last question has been processed. If not, then processing may return to step 442 of FIG. 4C, otherwise processing may continue to step 481 of FIG. 4E.

FIG. 4E depicts flow diagram 480 of fourth phase 240, generating a coaching report based on the test analysis of the participants test-taking and test results. FIG. 4E is described below with reference to FIGS. 5B through 5E as well as other Figures herein. Testing management system 362 may generate three detailed coaching reports providing mastery analysis, knowledge gap analysis and antipattern analysis as well as a summary coaching report. These four coaching reports may be combined into a single coaching report or may be generated concurrently as a single coaching report. In the present embodiment, the three detailed coaching reports are generated concurrently question by question, then the summary coaching report is generated. Alternative embodiments may provide different reports based on the test analysis of the present embodiment or of other embodiments. For example, rather than utilizing an AI tool to generate tailor made encouraging comments and summaries, the test management system may utilize a set of standardized comments.

Steps 481 through 489 are directed to describing generating detailed post-test coaching reports such as described with reference to FIGS. 5C-5E below. In a first step 481, test management system 362 may generate headers 542, 562 and 582 for each of the detailed coaching reports 540, 560 and 580. Each header may include a title and a standard brief explanation of that detailed coaching report. The following steps 482-488 may be repeated for each test question.

In step 482, test management system 362 may access mastery data 377C, knowledge gap data 377D and antipattern data 377E for the next question, starting with the first question. The test management system may also access participant's test score 375J, including identifying whether the question was answered correctly, incorrectly or not answered, although that may be discerned from the test results data.

In step 483, if the test question was answered correctly, test management system 362 may construct a mastery results prompt for an AI tool requesting that the AI tool provide a coaching comment regarding whether the participant mastered the correctly answered question with a grade appropriate encouraging comment including supporting evidence, such as may be provided by a teacher. This prompt may include participant's test score 375J with mastery data 377C including the determination whether the participant demonstrated mastery of the test question, and with supporting evidence.

In step 484, if the test question was answered incorrectly or not answered, test management system 362 may construct a knowledge gap results prompt for an AI tool requesting that the AI tool provide a coaching comment regarding whether the participant demonstrated any knowledge gaps with a grade appropriate encouraging comment including supporting evidence, such as may be provided by a teacher. This prompt may include participant's test score 375J with knowledge gap data 377D including the determination whether the participant demonstrated any knowledge gaps, and with supporting evidence.

In step 484, if the test question was answered incorrectly, test management system 362 may construct an antipattern results prompt for an AI tool requesting that the AI tool provide a coaching comment regarding whether the participant demonstrated any antipatterns with a grade appropriate encouraging comment including supporting evidence, such as may be provided by a teacher. This prompt may include participant's test score 375J with antipattern data 377E including the determination whether the participant demonstrated any antipatterns, and with supporting evidence.

In step 485, test management system 362 may submit the constructed mastery results prompt, knowledge gap results prompt and antipattern results prompt with associated data to the AI tool for the grade appropriate coaching comment regarding whether the participant demonstrated any mastery, knowledge gaps, or antipatterns with a grade appropriate encouraging comment including supporting evidence, such as may be provided by a teacher. These prompts may be submitted together as a single prompt or separately as multiple prompts. Some prompts may not be submitted, such as not submitting a mastery results prompt if the participant answered the question incorrectly.

In step 486, test management system 362 may receive the response(s) from the AI tool, including the encouraging comments with supporting evidence. Then in step 487, the test management system may add a section to the applicable detailed coaching reports 540, 560 and 580 based on the response from the AI tool with the question number, the determination of the AI tool, and the comments provided by the AI tool, including support evidence. For example, if the question had been answered correctly, a section may be added to detailed coaching report 540 providing mastery analysis including listing the question number, whether the participant mastered the question, did not master the question, or was inconclusive, as well as the encouraging comment with supporting evidence.

In step 487, the data provided by the AI tool for each of the mastery results prompt, knowledge gap results prompt and antipattern results prompt may be accumulated in accumulated data 377F of test results database 377 for use in generating the coaching report(s). Then in step 488, if there are more questions to the test, then the test management system may return processing to step 482, otherwise processing may continue to step 489. In step 489, the test management system may calculate and compare a percentage of questions mastered to a mastery threshold from threshold data 378B to determine whether the participant mastered the test. The test mastery system may store this test mastery determination in accumulated data 377F for use as described herein. Processing may then continue to step 490 for generating the summary coaching report.

Steps 490 through 498 are directed to describing generating a summary post-test coaching report such as described with reference to FIG. 5B below. Test management system 362 may generate the report out of linear order. That is, the test management system may generate a section located lower in the report page prior to generating a section located higher in the report page. The sections can then be formatted in a desired order after the sections have been generated.

In step 490, test management system 362 may generate header 521 of summary post-test coaching report 520. The header may include a title and a standard brief explanation of that summary post-test coaching report. The header may also include a session identifier 377A. Then in step 491, the test management system may generate a first numerical summary of the overall test results in a first numerical summary section 526 and a second numerical summary of the overall test results in a second numerical section 533. The first numerical summary section may include test identifier 373A, participant's overall score 375J as well as the max score, score percentage, test mastery determination, and the number of questions answered correctly, incorrectly or not answered 377F. The second numerical summary section may include the number of questions mastered, the number of questions indicating knowledge gaps, and the number of questions where antipatterns were detected 377F. In step 492, test management system 362 may generate a test result summary 525 utilizing a standard encouraging prose and including the participant's overall numerical test results. In an alternative embodiment, an AI tool may be utilized to generate this test result summary.

In step 493, test management system 362 may identify the three most common antipatterns from antipattern data 377E, which were detected during the test analysis. Then in step 494, the test management system may construct the summary post-test coaching prompt for an AI tool to provide brief grade appropriate encouraging summaries, such as may be provided by a teacher, of each of the identified most common antipatterns as well as a brief grade appropriate encouraging coaching summary, such as may be provided by a teacher, combining the identified most common antipatterns. In step 495, the test management system may submit the summary post-test coaching prompt to an AI tool for the requested antipattern summaries. In step 496, the test management system may receive the requested grade appropriate encouraging summaries from the AI tool. In step 497, the test management system may generate a coaching tips section 532 including the AI tool summaries of the three most common antipatterns as well as generate a coaching summary section 531 including the coaching summary combining the three most common antipatterns. Then in step 498, the test management system formats the post-test coaching report, including concatenating summary post-test coaching report 520 with detailed post-test coaching reports 540, 560 and 580 into a single post-test coaching report, and stores that concatenated report as post-test coaching report 377G in test results database 377. Finally, in step 499, test management system 362 may provide post-test coaching report 377G to the participant or other authorized persons as feedback regarding the participants test taking performance.

FIGS. 5A-5E depict a displayed screenshot of a participant annotated test question 500, a displayed summary post-test coaching report 520, and displayed detailed post-test coaching reports 540, 560 and 580. A description of the annotation of the screenshot depicted in FIG. 5A is provided above with reference to FIG. 4A. A description of the generation of the reports depicted in FIGS. 5B-5E is provided above with reference to FIG. 4E.

FIG. 5A depicts a screenshot of a displayed participant annotated test question 500 including participant annotations 510 and 512 as well as a system generated bounding box 518. In this example, the displayed test question may include a header 502 which includes a test identifier 373A and session identifier 377A. Below the header, the displayed test question may include the question text 506 including a test number 504. Below the question text, the displayed test question may include a set of possible answers 508. The participant may have annotated the question text with underlining 510, annotated the possible answers 508 by crossing out certain wrong answers 512 and circled the correct answer 514. The participant may have also annotated the displayed test question by drawing an equation 512 to calculate a solution of the displayed test question. In the present embodiment, the header, question text, and set of possible answers 508 may be in black while the participant annotations may be in red or another color. Also depicted is a bounding box 508 generated by the test management system for OCR as described above, which may not be visible to the participant when taking the test.

FIG. 5B depicts displayed summary post-test coaching report 520 including a summary of the participants test taking performance. Summary report 520 may include a header 521, a test result summary 525, a first numerical summary 526, a coaching summary 531, coaching tips 532, and a second numerical summary 533. Header 521 may include a title 522, a general description of the report 523, and session identifier 524. Test results summary 525 may include a brief encouraging summary of the participants test results including the participant overall numerical test results. First numerical summary may include a test identifier 527, an overall score 528, whether the participant mastered the test 529, and numerical scores 530 of the questions answered correctly, incorrectly or not answered. Coaching summary 531 and coaching tips 532 may include AI tool generated encouraging grade appropriate summaries of the three most common antipatterns detected from the participant's test results. Second numerical summary 533 may include a numerical summary of the questions mastered, questions where the participant demonstrated knowledge gaps and questions where the participant demonstrated antipatterns.

FIG. 5C depicts displayed detailed post-test coaching report 540 of providing mastery analysis of correctly answered questions. Report 540 may include a header 542 and test question results 550. Header 542 may include a title 544, a session identifier 545, a brief description 546 of this report, and column headers 548. Test question results 550 may include question numbers 552, a mastery determination 554, and coaching comments 556. Mastery determination 554, referred to here as status, indicate whether the participant mastered the identified question, did not master the identified question, or whether the mastery determination was inconclusive. Coaching comments 556 include AI tool provided grade appropriate encouraging comments, including supporting evidence, regarding the participant's mastery of the subject matter of the question. Additional test question results 550 may be provided of additional correctly answered questions.

FIG. 5D depicts displayed detailed post-test coaching report 560 of providing knowledge gap analysis of incorrectly answered and unanswered questions. Report 560 may include a header 562 and test question results 570. Header 562 may include a title 564, a session identifier 565, a brief description 566 of this report, and column headers 568. Test question results 570 may include question numbers 572, a knowledge gap determination 574, and coaching comments 576. Knowledge gap determination 574, referred to here as status, indicate whether the participant exhibited apparent knowledge gaps regarding the identified question. In the present embodiment, only questions indicating a knowledge gap may be listed in this report. In an alternative embodiment, questions not indicating knowledge gaps may be listed as a positive affirmation. Coaching comments 576 include AI tool provided grade appropriate encouraging comments, including supporting evidence, regarding the participant's apparent knowledge gaps regarding the subject matter of the question.

FIG. 5E depicts displayed detailed post-test coaching report 580 of providing antipattern analysis of incorrectly answered questions. Report 580 may include a header 582 and test question results 590. Header 582 may include a title 584, a session identifier 585, a brief description 586 of this report, and column headers 588. Test question results 590 may include question numbers 592, an antipattern identification 594, and coaching comments 596. Antipattern determination 594, referred to here as status, indicate whether the participant exhibited antipatterns while answering the identified question. Coaching comments 576 include AI tool provided grade appropriate encouraging comments, including supporting evidence, regarding the participant's apparent antipatterns. In the present embodiment, the term antipatterns may be replaced in many areas with an alternative term such as carelessness.

Alternative embodiments may utilize additional coaching reports, test question formats, or other variations of the depicted reports and question formats as may be appreciated by one of ordinary skill in the art. For example, the mastery, knowledge gap and antipattern detailed coaching reports may be combined into a single detailed report listing every question in order with one or more such determinations, including whether the participant answered correctly, incorrectly or did not answer.

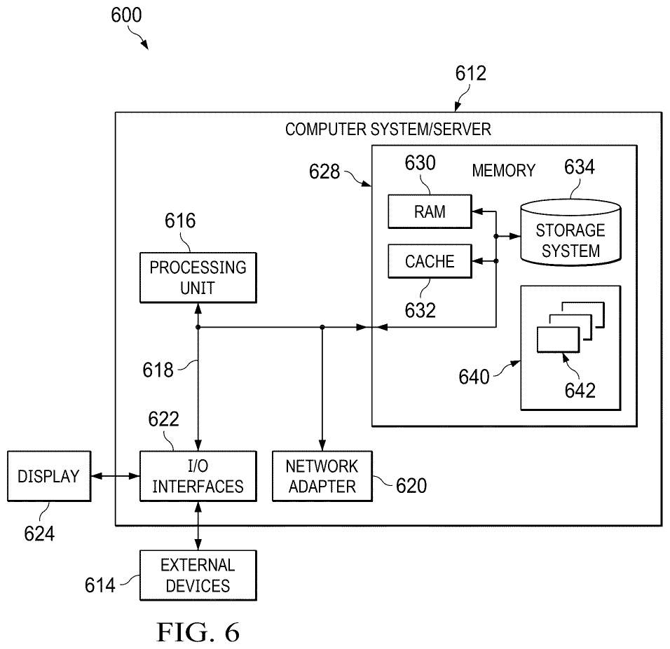

FIG. 6 depicts a block diagram of an illustrative data processing system in which various embodiments of the present disclosure may be implemented. Data processing system 600 is one example of a suitable data processing system and is not intended to suggest any limitation as to the scope of use or functionality of the embodiments described herein. Regardless, data processing system 600 is capable of being implemented and/or performing any of the functionality set forth herein such as automatically evaluating participant online testing and automatically providing feedback regarding test results and participant subject matter comprehension.

In data processing system 600 there is a computer system/server 612, which is operational with numerous other computing system environments, peripherals, or configurations. Examples of well-known computing systems, environments, and/or configurations that may be suitable for use with computer system/server 612 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 612 may be described in the general context of computer system-performable instructions, such as program modules, being processed by a computer system. Generally, program modules may include routines, programs, objects, components, logic, data structures, and so on that perform particular tasks or implement particular abstract data types. Computer system/server 612 may be practiced in distributed computing environments where tasks are performed by remote processing devices that are linked through a communications network. In a distributed computing environment, program modules may be located in both local and remote computer system storage media including memory storage devices. For example, various embodiments of the systems and methods such as described herein may be implemented in a cloud computing environment, distributed or otherwise, which may be virtualized such as with the use of a hypervisor managing multiple nodes including virtual processors, virtual memory, etc.

As depicted in FIG. 6, computer system/server 612 in data processing system 600 is shown in the form of a general-purpose computing device. The components of computer system/server 612 may include, but are not limited to, one or more processors or processing units 616, a system memory 628, and a bus 618 that couples various system components including system memory 628 to processor 616.

Bus 618 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 612 typically includes a variety of non-transitory computer system usable media. Such media may be any available media that is accessible by computer system/server 612, and it includes both volatile and non-volatile media, removable and non-removable media.

System memory 628 may include non-transitory computer system readable media in the form of volatile memory, such as random access memory (RAM) 630 and/or cache memory 632. Computer system/server 612 may further include other non-transitory removable/non-removable, volatile/non-volatile computer system storage media. By way of example, storage system 634 can be provided for reading from and writing to a non-removable, non-volatile magnetic media (not shown and typically called a “hard drive”). Although not shown, a USB interface for reading from and writing to a removable, non-volatile magnetic chip (e.g., a “flash drive”), and an optical disk drive for reading from or writing to a removable, non-volatile optical disk such as a CD-ROM, DVD-ROM or other optical media can be provided. In such instances, each can be connected to bus 618 by one or more data media interfaces. Memory 628 may include at least one program product having a set (e.g., at least one) of program modules that are configured to carry out the functions of the embodiments. Memory 628 may also include data that will be processed by a program product.

Program/utility 640, having a set (at least one) of program modules 642, may be stored in memory 628 by way of example, and not limitation, as well as an operating system, one or more application programs, other program modules, and program data. Each of the operating system, one or more application programs, other program modules, and program data or some combination thereof, may include an implementation of a networking environment. Program modules 642 generally carry out the functions and/or methodologies of the embodiments. For example, a program module may be software for automatically evaluating participant online testing and automatically providing feedback regarding test results and participant subject matter comprehension.

Computer system/server 612 may also communicate with one or more external devices 614 such as a keyboard, a pointing device, a display 624, etc.; one or more devices that enable a user to interact with computer system/server 612; and/or any devices (e.g., network card, modem, etc.) that enable computer system/server 612 to communicate with one or more other computing devices. Such communication can occur via I/O interfaces 622 through wired connections or wireless connections. Still yet, computer system/server 612 can communicate with one or more networks such as a local area network (LAN), a general wide area network (WAN), and/or a public network (e.g., the internet) via network adapter 620. As depicted, network adapter 620 communicates with the other components of computer system/server 612 via bus 618. It should be understood that although not shown, other hardware and/or software components could be used in conjunction with computer system/server 612. Examples, include, but are not limited to: microcode, device drivers, tape drives, RAID systems, redundant processing units, data archival storage systems, external disk drive arrays, etc.

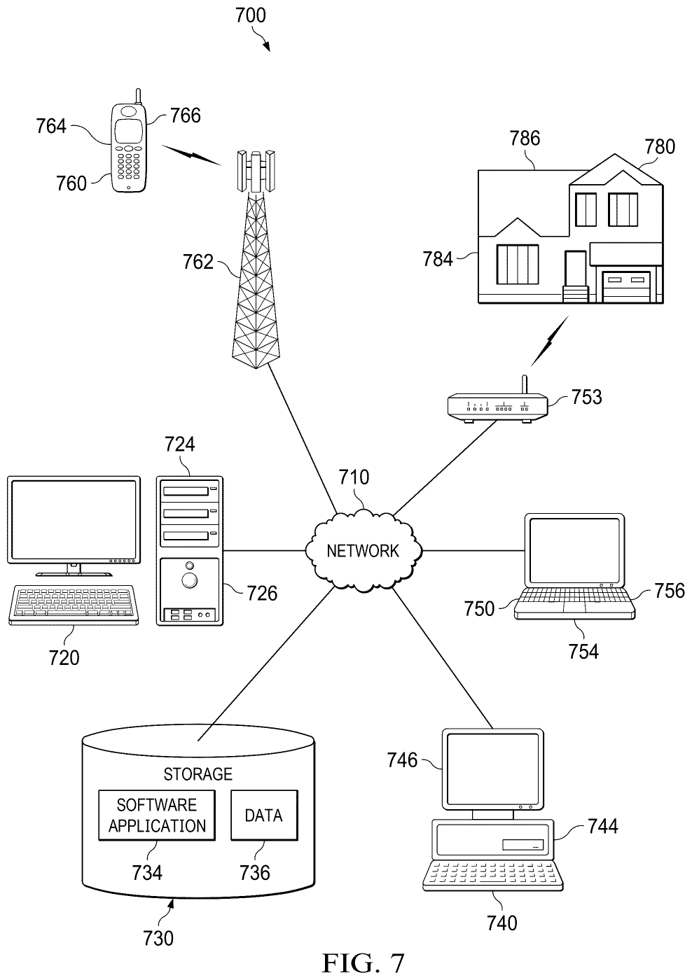

FIG. 7 depicts a block diagram of an illustrative network of data processing systems in which various embodiments of the present disclosure may be implemented. Data processing environment 700 is a network of data processing systems such as described above with reference to FIG. 6. Software applications such as for automatically evaluating participant online testing and automatically providing feedback regarding test results and participant subject matter comprehension may be processed on any computer or other type of data processing system in data processing environment 700. Data processing environment 700 includes network 710. Network 710 is the medium used to provide simplex, half duplex and/or full duplex communications links between various devices and computers connected together within data processing environment 700. Network 710 may include connections such as wire, wireless communication links, or fiber optic cables.

Server 720 and client 740 are coupled to network 710 along with storage unit 730. In addition, laptop 750 and facility 780 (such as a home or business) are coupled to network 710 including wirelessly such as through a network router 753. A mobile device 760 such as a mobile phone may be coupled to network 710 through a cell tower 762. Data processing systems, such as server 720, client 740, laptop 750, mobile device 760 and facility 780 contain data and have software applications including software tools processing thereon. Other types of data processing systems such as personal digital assistants (PDAs), smartphones, tablets and netbooks may be coupled to network 710.

Server 720 may include software application 724 and data 726 for automatically evaluating participant online testing and automatically providing feedback regarding test results and participant subject matter comprehension or other software applications and data in accordance with embodiments described herein. Storage 730 may contain software application 734 and a content source such as data 736 for automatically evaluating participant online testing and automatically providing feedback regarding test results and participant subject matter comprehension. Other software and content may be stored on storage 730 for sharing among various computer or other data processing devices. Client 740 may include software application 744 and data 746. Laptop 750 and mobile device 760 may also include software applications 754 and 764 and data 756 and 766. Facility 780 may include software applications 784 and data 786 on local data processing equipment. Other types of data processing systems coupled to network 710 may also include software applications. Software applications could include a web browser, email, or other software application for automatically evaluating participant online testing and automatically providing feedback regarding test results and participant subject matter comprehension.

Server 720, storage unit 730, client 740, laptop 750, mobile device 760, and facility 780 and other data processing devices may couple to network 710 using wired connections, wireless communication protocols, or other suitable data connectivity. Client 740 may be, for example, a personal computer or a network computer.

In the depicted example, server 720 may provide data, such as boot files, operating system images, and applications to client 740 and laptop 750. Server 720 may be a single computer system or a set of multiple computer systems working together to provide services in a client server environment. Client 740 and laptop 750 may be clients to server 720 in this example. Client 740, laptop 750, mobile device 760 and facility 780 or some combination thereof, may include their own data, boot files, operating system images, and applications. Data processing environment 700 may include additional servers, clients, and other devices that are not shown.

In the depicted example, data processing environment 700 may be the internet. Network 710 may represent a collection of networks and gateways that use the Transmission Control Protocol/Internet Protocol (TCP/IP) and other protocols to communicate with one another. At the heart of the internet is a backbone of data communication links between major nodes or host computers, including thousands of commercial, governmental, educational, and other computer systems that route data and messages. Of course, data processing environment 700 also may be implemented as a number of different types of networks, such as for example, an intranet, a local area network (LAN), or a wide area network (WAN). FIG. 7 is intended as an example, and not as an architectural limitation for the different illustrative embodiments.

Among other uses, data processing environment 700 may be used for implementing a client server environment in which the embodiments may be implemented. A client server environment enables software applications and data to be distributed across a network such that an application functions by using the interactivity between a client data processing system and a server data processing system. Data processing environment 700 may also employ a service oriented architecture where interoperable software components distributed across a network may be packaged together as coherent business applications.

Embodiments of the system and method for automatically evaluating participant online testing and automatically providing feedback regarding test results and participant subject matter comprehension may be implemented in any manner including as a computer program product at any possible technical detail level of integration. The computer program product may include a computer readable storage medium (or media) having computer readable program instructions thereon for causing a processor to carry out elements of the embodiments of the system and method for automatically evaluating participant online testing and automatically providing feedback regarding test results and participant subject matter comprehension.

The computer readable storage medium can be a tangible device that can retain and store instructions for use by an instruction processing device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present system and method may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++ or the like, and procedural programming languages, such as the “C” programming language or other programming languages such as Java. The computer readable program instructions may be processed entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the internet using an Internet Service Provider). In some embodiments, electronic circuitry including, for example, programmable logic circuitry, field-programmable gate arrays (FPGA), or programmable logic arrays (PLA) may process the computer readable program instructions by utilizing state information of the computer readable program instructions to personalize the electronic circuitry, in order to perform elements of the system and method for automatically evaluating participant online testing and automatically providing feedback regarding test results and participant subject matter comprehension.

Elements of the present system and method are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer or other programmable data processing apparatus to produce a special purpose machine, such that the instructions, which are processed via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement elements of the function/act specified in the flowchart and/or block diagram block or blocks.

The computer readable program instructions may also be loaded onto a computer, other programmable data processing apparatus, or other device to cause a series of operations to be performed on the computer, other programmable apparatus or other device to produce a computer implemented process, such that the instructions which are processed on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present system and method. In this regard, each block in the flowchart or block diagrams may represent a module, segment, or portion of instructions, which comprises one or more performable instructions for implementing the specified logical function(s). In some alternative implementations, the functions noted in the blocks may occur out of the order noted in the Figures. For example, two blocks shown in succession may, in fact, be processed substantially concurrently, or the blocks may sometimes be processed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A data processing system suitable for storing and/or processing program code will include at least one processor coupled directly or indirectly to memory elements through a system bus. The memory elements can include local memory employed during actual processing of the program code, bulk storage media, and cache memories, which provide temporary storage of at least some program code in order to reduce the number of times code must be retrieved from bulk storage media during processing.

A data processing system may act as a server data processing system or a client data processing system. Server and client data processing systems may include data storage media that are computer usable, such as being computer readable. A data storage medium associated with a server data processing system may contain computer usable code such as for automatically evaluating participant online testing and automatically providing feedback regarding test results and participant subject matter comprehension. A client data processing system may download that computer usable code, such as for storing on a data storage medium associated with the client data processing system, or for using in the client data processing system. The server data processing system may similarly upload computer usable code from the client data processing system such as a content source. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The descriptions of the various embodiments of the present system and method have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The terminology used herein is for the purpose of describing particular embodiments and is not intended to be limiting of the present system and method. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or operations plus function elements in the claims below are intended to include any structure, material, or act for performing the function in combination with other claimed elements as specifically claimed. The description of the present system and method has been presented for purposes of illustration and description, but is not intended to be exhaustive or limited to the system and method for automatically evaluating participant online testing and automatically providing feedback regarding test results and participant subject matter comprehension in the form disclosed. Many modifications and variations will be apparent to those of ordinary skill in the art. The embodiment was chosen and described in order to best explain the principles of the system and method and the practical application, and to enable others of ordinary skill in the art to understand the system and method for various embodiments with various modifications as are suited to the particular use contemplated.

What is claimed is:

1. A method of automatically evaluating participant online testing and automatically providing feedback regarding test results and participant subject matter comprehension, the method comprising:
receiving notification to automatically evaluate a participant test including video with video frames, audio, timestamped screenshots, and initial test results of the participant answering multiple test questions, the initial test results indicating which test questions were answered correctly, incorrectly, or not answered;
transcribing the audio;
utilizing optical character recognition (OCR) on the screenshots to generate a set of text for each screenshot;
comparing the set of text from each timestamped screenshot to determine which screenshots are associated with each test question;
determining a set of time periods for each question based on the timestamps of the screenshots associated with each test question;
segmenting the transcribed audio, the screenshots, and the video frames by question based on the determined set of time periods;
selecting a screenshot and a video frame for each test question from the segmented screenshots and video frames;
utilizing a first AI tool to generate an ideal answer for each test question;
utilizing a second AI tool, with the ideal answer, the segmented transcribed audio, the selected screenshot and the selected video frame, for determining whether the participant demonstrated mastery of each correctly answered test question thereby indicating subject matter performance;
utilizing the second AI tool, with the ideal answer, the segmented transcribed audio, the selected screenshot and the selected video frame, for determining whether the participant indicated knowledge gaps for each incorrectly answered test question;
utilizing the second AI tool, with the segmented transcribed audio, the selected screenshot and the selected video frame, for determining whether the participant indicated antipatterns for each incorrectly answered test question;
generating a coaching report including the mastery determinations, the knowledge gap determinations and the antipattern determinations; and
providing the coaching report to the participant.

2. The method of claim 1 further comprising utilizing a third AI tool to identify annotated screenshots from the segmented screenshots; wherein the selected screenshot for each test question is the last annotated screenshot associated with that test question.

3. The method of claim 1 further comprising utilizing OCR on the video frames associated with each test question; and identifying a number of identified characters for each OCR'd video frame; wherein the selected video frame for each test question is the video frame with the most identified characters for the time period determined for that test question.

4. The method of claim 1 further comprising receiving text for each of the multiple test questions including a correct answer for each test question; wherein the text and correct answer for each test question is utilized for generating the ideal answer for each test question.

5. The method of claim 1 further comprising including a call to a fourth AI tool to generate a solution for any equation included in any of the multiple test questions.

6. The method of claim 1 wherein the first AI tool is directed to generate a grade appropriate ideal answer.

7. The method of claim 1 wherein the first and third AI tools are the same AI tool.

8. A non-transitory, computer program product for automatically evaluating participant online testing and automatically providing feedback regarding test results and participant subject matter comprehension, the computer program product comprising a computer readable storage medium having program instructions embodied therewith, the program instructions processed by a processing circuit to cause the device to perform a method comprising the operations of:
receiving notification to automatically evaluate a participant test including video with video frames, audio, timestamped screenshots, and initial test results of the participant answering multiple test questions, the initial test results indicating which test questions were answered correctly, incorrectly, or not answered;
transcribing the audio;
utilizing OCR on the screenshots to generate a set of text for each screenshot;
comparing the set of text from each timestamped screenshot to determine which screenshots are associated with each test question;
determining a set of time periods for each question based on the timestamps of the screenshots associated with each test question;
segmenting the transcribed audio, the screenshots, and the video frames by question based on the determined set of time periods;
selecting a screenshot and a video frame for each test question from the segmented screenshots and video frames;
utilizing a first AI tool to generate an ideal answer for each test question;
utilizing a second AI tool, with the ideal answer, the segmented transcribed audio, the selected screenshot and the selected video frame, for determining whether the participant demonstrated mastery of each correctly answered test question thereby indicating subject matter performance;
utilizing the second AI tool, with the ideal answer, the segmented transcribed audio, the selected screenshot and the selected video frame, for determining whether the participant indicated knowledge gaps for each incorrectly answered test question;
utilizing the second AI tool, with the segmented transcribed audio, the selected screenshot and the selected video frame, for determining whether the participant indicated antipatterns for each incorrectly answered test question;
generating a coaching report including the mastery determinations, the knowledge gap determinations and the antipattern determinations; and
providing the coaching report to the participant.

9. The computer program product claim 8 further comprising utilizing a third AI tool to identify annotated screenshots from the segmented screenshots; wherein the selected screenshot for each test question is the last annotated screenshot associated with that test question.

10. The computer program product of claim 8 further comprising utilizing OCR on the video frames associated with each test question; and identifying a number of identified characters for each OCR'd video frame; wherein the selected video frame for each test question is the video frame with the most identified characters for the time period determined for that test question.

11. The computer program product of claim 8 further comprising receiving text for each of the multiple test questions including a correct answer for each test question; wherein the text and correct answer for each test question is utilized for generating the ideal answer for each test question.

12. The computer program product of claim 8 further comprising including a call to a fourth AI tool to generate a solution for any equation included in any of the multiple test questions.

13. The computer program product of claim 8 wherein the first AI tool is directed to generate a grade appropriate ideal answer.

14. A data processing system for automatically evaluating participant online testing and automatically providing feedback regarding test results and participant subject matter comprehension, the data processing system comprising:
a processor; and
a memory storing program instructions which when processed by the
processor perform the operations of:
receiving notification to automatically evaluate a participant test including video with video frames, audio, timestamped screenshots, and initial test results of the participant answering multiple test questions, the initial test results indicating which test questions were answered correctly, incorrectly, or not answered;
transcribing the audio;
utilizing OCR on the screenshots to generate a set of text for each screenshot;
comparing the set of text from each timestamped screenshot to determine which screenshots are associated with each test question;
determining a set of time periods for each question based on the timestamps of the screenshots associated with each test question;
segmenting the transcribed audio, the screenshots, and the video frames by question based on the determined set of time periods;
selecting a screenshot and a video frame for each test question from the segmented screenshots and video frames;
utilizing a first AI tool to generate an ideal answer for each test question;
utilizing a second AI tool, with the ideal answer, the segmented transcribed audio, the selected screenshot and the selected video frame, for determining whether the participant demonstrated mastery of each correctly answered test question thereby indicating subject matter performance;
utilizing the second AI tool, with the ideal answer, the segmented transcribed audio, the selected screenshot and the selected video frame, for determining whether the participant indicated knowledge gaps for each incorrectly answered test question;
utilizing the second AI tool, with the segmented transcribed audio, the selected screenshot and the selected video frame, for determining whether the participant indicated antipatterns for each incorrectly answered test question;
generating a coaching report including the mastery determinations, the knowledge gap determinations and the antipattern determinations; and
providing the coaching report to the participant.

15. The data processing system of claim 14 further comprising utilizing a third AI tool to identify annotated screenshots from the segmented screenshots; wherein the selected screenshot for each test question is the last annotated screenshot associated with that test question.

16. The data processing system of claim 14 further comprising utilizing OCR on the video frames associated with each test question; and identifying a number of identified characters for each OCR'd video frame; wherein the selected video frame for each test question is the video frame with the most identified characters for the time period determined for that test question.

17. The data processing system of claim 14 further comprising receiving text for each of the multiple test questions including a correct answer for each test question; wherein the text and correct answer for each test question is utilized for generating the ideal answer for each test question.

18. The data processing system of claim 14 further comprising including a call to a fourth AI tool to generate a solution for any equation included in any of the multiple test questions.

19. The data processing system of claim 14 wherein the first AI tool is directed to generate a grade appropriate ideal answer.

20. The data processing system of claim 14 wherein the first and third AI tools are the same AI tool.
